(19) United States
(12) Patent Application Publication
(10) Pub. No.: US 2026/0281896 A1
(43) Pub. Date: Sep. 17, 2026

(54) METHOD, USER EQUIPMENT AND ACCESS NETWORK NODE

(71) Applicant: NEC Corporation, Tokyo (JP)

(72) Inventors: Maxime GRAU, Guildford (GB); Xuelong WANG, Guildford (GB); Carloine LIANG, Guildford (GB)

(73) Assignee: NEC Corporation, Tokyo (JP)

(21) Appl. No.: 19/168,850

(22) PCT Filed: Mar. 25, 2024
(86) PCT No.: PCT/JP2024/011744

§ 371 Date: Sep. 25, 2025

(30) Foreign Application Priority Data
Apr. 5, 2023 (GB) 2305077.6

(51) Int. Cl. H04W 52/02; H04W 72/11

(52) U.S. Cl. CPC H04W 52/0216; H04W 52/0235; H04W 72/11

(57) ABSTRACT

Various access network nodes and user equipment are disclosed that can operate both semi persistent scheduling and cell DTX/DRX. One disclosed method performed by a user equipment, UE, the method comprising: receiving, from an access network node, a first downlink transmission; determining that a timing of a procedure related to the first donwlink transmission overlaps a cell discontinuous transmission, DTX,/discontinuous reception, DRX, inactive period of the access network node; and delaying or stopping starting the procedure related to the first downlink transmission.

### TECHNICAL FIELD

The present disclosure relates to a communication system and to parts thereof.

### BACKGROUND ART

The disclosure has particular but not exclusive relevance to wireless communication systems and devices thereof operating according to the 3rd Generation Partnership Project (3GPP) standards or equivalents or derivatives thereof (including LTE-Advanced, Next Generation or 5G networks, future generations, and beyond). The disclosure has particular, although not necessarily exclusive, relevance to cell discontinuous reception (DRX) and cell discontinuous transmission (DTX) to reduce energy consumption within the network and the ramifications of using such network energy saving (NES) techniques with regard to Configured Grants (CG) that have been allocated to user equipment (UE) and Buffer Status Reporting (BSR).

Recent developments of the 3GPP standards are referred to as the Long-Term Evolution (LTE) of Evolved Packet Core (EPC) network and Evolved UMTS Terrestrial Radio Access Network (E-UTRAN), also commonly referred as ‘4G’. In addition, the term ‘5G’ and ‘new radio’ (NR) refer to an evolving communication technology that is expected to support a variety of applications and services. Various details of 5G networks are described in, for example, the ‘NGMN 5G White Paper’ V1.0 by the Next Generation Mobile Networks (NGMN) Alliance, which document is available from https://www.ngmn.org/5g-white-paper.html. 3GPP intends to support 5G by way of the so-called 3GPP Next Generation (NextGen) radio access network (RAN) and the 3GPP NextGen core network.

Under the 3GPP standards, a NodeB (or an eNB in LTE, gNB in 5G) is the radio access network (RAN) node (or simply ‘access node’, ‘access network node’ or ‘base station’) via which communication devices (user equipment or ‘UE’) connect to a core network and communicate with other communication devices or remote servers. For simplicity, the present application will use the term RAN node or base station to refer to any such access nodes.

There is a need for improved wireless communication networks having improved energy efficiency. A reduction in the amount of energy needed to operate a communication network beneficially reduces the environmental impact of operating the system, and also reduces the operational costs. Moreover, for battery-powered devices (for example, a UE) reduced power consumption extends the battery life of the device.

One method of achieving a more efficient communication network is to reduce the energy requirements of the radio access network part of the system. The energy consumption of the radio access network includes a dynamic part that is associated with data transmission and reception, and a static part that is associated with operations of the radio access devices that are performed even when there is no ongoing data transmission or reception. The static part may include, for example, the power required to operate a UE in a mode in which the UE is able to receive and decode a physical downlink control channel (PDCCH) transmitted by a base station. Energy saving modes may be configured for one or more devices in the system (e.g. a UE). For example, a UE may be configured to operate in an energy saving mode (which may also be referred to as a sleep mode) in which the UE performs a reduced number of transmissions, or in which the UE is configured not to attempt to transmit or receive signals during a particular time 5 period. Such operation is commonly referred to as DRX/DTX which stands for Discontinuous Reception (DRX) and Discontinuous Transmission (DTX).

### CITATION LIST

### Non Patent Literature

NPL 1: The ‘NGMN 5G White Paper’ V1.0 by the Next Generation Mobile Networks (NGMN) Alliance, available from https://www.ngmn.org/5g-white-paper.html.

### SUMMARY OF INVENTION

### Technical Problem

Many proposals have been made for UE DTX/DRX operation and attention is turning now to such discontinuous operation of one or more base station cells-which is referred to as “cell DTX/DRX”. With cell DTX/DRX, the cell (RAN node) stops transmitting and receiving during certain periods of time and the UEs that are served by the cell should know when the RAN node is in the active state (and is therefore able to communicate with the UE) and when it is in the inactive state (and is therefore not able to communicate with the UE). However, the introduction of such cell DTX/DRX has ramifications for other features of the communication system and in particular on Semi Persistently Scheduling (SPS) resources that have been allocated to UEs.

More specifically, when the base station has data to transmit to a UE, the base station must configure the UE to receive the data. Specifically, the base station has to tell the UE that it is going to send data to the UE in a current time slot and it must tell the UE which (time and frequency) resources the base station will use to transmit the data to the UE. However, this process can be quite inefficient particularly when there is regular data to be transmitted to the UE (for instance when the UE is downloading a large file or when the UE is in a call). To cater for this, the base station can use Semi Permanent Scheduling (SPS) to allocate to the UE periodic resources that will be used to carry downlink data. These downlink SPS resources are configured by the base station in an RRC configuration message. Since a cell is only configured for cell DTX/DRX during periods when the cell is not busy, the base station does not know when it might transition into a cell DTX/DRX inactive period at the time that it configures UEs with these periodic SPS resources and therefore it is possible that the base station may be in a DTX/DRX inactive period at the time when a particular UE has been scheduled to receive downlink data or is supposed to transmit an acknowledgement for data it has received. The base station and the UEs need to know what to do in this situation.

There is therefore a need to provide solutions for these scenarios. The disclosure aims to provide apparatus and methods that at least partially addresses one or more of the above needs and/or issues.

### Solution to Problem

According to one aspect, the present disclosure provides a method performed by a user equipment, UE, the method comprising: receiving first data of a first downlink transmission from an access network node; in a case where the first downlink transmission is not successfully received, transmitting a non-acknowledgement, NACK, to the access network node; configuring a first timer indicating how long after transmitting the NACK to the access network node, the UE can expect to wait before receiving a retransmission of the downlink data transmission from the access network node; configuring a second timer that runs after the first timer and which indicates a time period over which the UE should be awake to receive the retransmission of the first downlink transmission from the access network node; receiving first information indicating a discontinuous transmission, DTX, configuration of the access network node defining an active period in which the access network node is supposed to be active and configured to communicate with the UE and an inactive period in which the access network node is supposed to be inactive and configured not to communicate with the UE; determining if the second timer in respect of the first downlink transmission overlaps with said inactive period of the access network node; and in a case where the second timer overlaps with the inactive period, delaying starting of the second timer until the access network node is in the active period following the end of the inactive period.

In a case where the first timer has started following the transmission of the NACK, the method may extend the first timer so that the first timer stops at the end of the inactive period. In a case where the first timer has not started following the transmission of the NACK, the method may skip the running of the first timer.

According to another aspect, the present disclosure provides a method performed by a user equipment, UE, the method comprising: receiving first data of a first downlink transmission from an access network node; in a case where the first downlink transmission is not successfully received, transmitting a non-acknowledgement, NACK, to the access network node; configuring a first timer indicating how long after transmitting the NACK to the access network node, the UE can expect to wait before receiving a retransmission of the downlink data transmission from the access network node; configuring a second timer that runs after the first timer and which indicates a time period over which the UE should be awake to receive the retransmission of the first downlink transmission from the access network node; receiving first information indicating a discontinuous transmission, DTX, configuration of the access network node defining an active period in which the access network node is supposed to be active and configured to communicate with the UE and an inactive period in which the access network node is supposed to be inactive and configured not to communicate with the UE; determining if the first timer in respect of the first downlink transmission is due to end during said inactive period of the access network node; and in a case where the first timer is due to end within the inactive period, extending the first timer so that the first timer stops at the end of the inactive period.

According to another aspect, the present disclosure provides a method performed by a user equipment, UE, the method comprising: receiving from an access network node a Semi-Persistent Scheduling, SPS, configuration that defines a plurality of downlink transmission occasions in which the access network node can transmit downlink data to the UE; receiving first information indicating a discontinuous transmission, DTX, configuration of the access network node defining an active period in which the access network node is supposed to be active and configured to communicate with the UE and an inactive period in which the access network node is supposed to be inactive and configured not to communicate with the UE; determining from the SPS configuration and said first information, if the access network node is in said inactive period during any time slot configured for an SPS downlink transmission; in the case where the access network node is in said inactive period during a time slot configured for an SPS downlink transmission skipping the monitoring of a downlink channel in said time slot unless the UE receives an indication from the access network node that the UE should monitor the downlink channel for that time slot.

The UE may receive the indication from the access network node on a broadcast channel or in UE specific downlink control information. The may UE skip the monitoring of a downlink control channel and/or a downlink shared data channel.

According to another aspect, the present disclosure provides a method performed by a user equipment, UE, the method comprising: receiving from an access network node a Semi-Persistent Scheduling, SPS, configuration that defines a plurality of downlink transmission occasions in which the access network node can transmit downlink data to the UE; receiving first information indicating a discontinuous reception, DRX, configuration of the access network node defining an active period in which the access network node is supposed to be active and configured to communicate with the UE and an inactive period in which the access network node is supposed to be inactive and configured not to communicate with the UE; receiving first data of a first downlink transmission transmitted by the access network node in a first time slot; in a case where the first downlink transmission is not successfully received, determining a second time slot, after said first time slot, in which to transmit a non-acknowledgement, NACK, to the access network node in a case where the first downlink transmission is not successfully received, or an acknowledgement, ACK, to the access network node in a case where the first downlink transmission is successfully received; checking if the second time slot overlaps with said inactive period; and in a case where the access network node is in said inactive period during said second time slot, delaying sending of the ACK/NACK to a third time slot that is after the second time slot and that overlaps with the active period of the access network node.

The second time slot may be determined by adding a predefined number of slots to the first time slot and the third time slot may be determined by adding an integer multiple of said predetermined number of slots to said second time slot. A counter may be used to count the predefined number of slots and is restarted one or more times until the determined third time slot does not overlap with said inactive period.

Alternatively, the method may further comprise determining a duration of the inactive period in time slots, determining the second time slot by adding a predefined number of slots to the first time slot and determining the third time slot by adding the duration of the inactive period to the second time slot.

According to another aspect, the present disclosure provides a method performed by a user equipment, UE, the method comprising: receiving from an access network node a Semi-Persistent Scheduling, SPS, configuration that defines a plurality of downlink transmission occasions in which the access network node can transmit downlink data to the UE; receiving first information indicating a discontinuous reception, DRX, configuration of the access network node defining an active period in which the access network node is supposed to be active and configured to communicate with the UE and an inactive period in which the access network node is supposed to be inactive and configured not to communicate with the UE; receiving first data of a first downlink transmission transmitted by the access network node in a first time slot; determining a second time slot, after said first time slot, in which to transmit a non-acknowledgement, NACK, to the access network node in a case where the first downlink transmission is not successfully received or an acknowledgement, ACK, to the access network node in a case where the first downlink transmission is successfully received; in a case where the access network node will be in said inactive period during said second time slot, receiving from the access network node an indication of when the UE should transmit the ACK/NACK in a time slot that skips the inactive period. The indication may be received from the access network node in a downlink control channel.

The first time slot may correspond to an SPS transmission occasion, and in the case that the first downlink transmission is not successfully received, the method may maintain the first data in an HARQ buffer for use in decoding a subsequent retransmission of the first downlink transmission.

Alternatively, the first downlink transmission may comprises an SPS release command, in which case the first downlink transmission may be received in a downlink control channel.

According to another aspect, the present disclosure provides a method performed by an access network node, the method comprising: transmitting first data of a first downlink transmission to a User Equipment, UE; receiving a non-acknowledgement, NACK, from the UE in a case where the first downlink transmission is not successfully received; transmitting first configuration data to the UE for configuring a first timer that indicates how long after transmitting the NACK to the access network node, the UE can expect to wait before the access network node retransmits the first downlink transmission to the UE; transmitting second configuration data to the UE for configuring a second timer that runs after the first timer and which indicates a time period over which the UE should be awake to receive the retransmission of the first downlink transmission from the access network node; transmitting third configuration data indicating a discontinuous transmission, DTX, configuration of the access network node defining an active period in which the access network node is supposed to be active and configured to communicate with the UE and an inactive period in which the access network node is supposed to be inactive and configured not to communicate with the UE; determining if the first timer in respect of the first downlink transmission stops within the inactive period or if the second timer in respect of the first downlink transmission overlaps with said inactive period; and in a case where the first downlink transmission stops within the inactive period or second timer overlaps with the inactive period, delaying retransmitting the first data transmission until the access network node is in the active period following the end of the inactive period.

According to another aspect, the present disclosure provides a method performed by an access network node, the method comprising: transmitting to a User Equipment a Semi-Persistent Scheduling, SPS, configuration that defines a plurality of downlink transmission occasions in which the access network node can transmit downlink data to the UE; transmitting first information indicating a discontinuous transmission, DTX, configuration of the access network node defining an active period in which the access network node is supposed to be active and configured to communicate with the UE and an inactive period in which the access network node is supposed to be inactive and configured not to communicate with the UE; determining from the SPS configuration and said first information, if the access network node is in said inactive period during a time slot configured for an SPS downlink transmission to the UE; in the case where the access network node will transmit a downlink transmission to the UE during said inactive period, transmitting an indication to the UE that the UE should monitor the downlink channel for that time slot.

The indication may be transmitted to the UE on a broadcast channel or in UE specific downlink control information.

According to another aspect, the present disclosure provides a method performed by an access network node, the method comprising: transmitting to a user equipment, UE, a Semi-Persistent Scheduling, SPS, configuration that defines a plurality of downlink transmission occasions in which the access network node can transmit downlink data to the UE; transmitting to the UE first information indicating a discontinuous reception, DRX, configuration of the access network node defining an active period in which the access network node is supposed to be active and configured to communicate with the UE and an inactive period in which the access network node is supposed to be inactive and configured not to communicate with the UE; transmitting a first downlink transmission to the UE in a first time slot; determining a second time slot, after said first time slot, in which the access network node expects to receive a non-acknowledgement, NACK, from the UE in a case where the first downlink transmission is not successfully received by the UE or an acknowledgement, ACK, from the UE in a case where the first downlink transmission is successfully received by the UE; checking if the second time slot overlaps with said inactive period; and in a case where the access network node is in said inactive period during said second time slot, maintaining said first downlink transmission in an HARQ buffer until a third time slot that is after the second time slot and that overlaps with the active period of the access network node.

In some aspects, the second time slot is determined by adding a predefined number of slots to the first time slot and the third time slot is determined by adding an integer multiple of said predetermined number of slots to said second time slot. A counter may be used to count the predefined number of slots and is restarted one or more times until the determined third time slot does not overlap with said inactive period.

In other aspects, the second time slot is determined by adding a predefined number of slots to the first time slot and the third time slot is determined by adding the duration of the inactive period to the second time slot.

According to another aspect, the present disclosure provides a method performed by an access network node, the method comprising: transmitting to a user equipment, UE, a Semi-Persistent Scheduling, SPS, configuration that defines a plurality of downlink transmission occasions in which the access network node can transmit downlink data to the UE; transmitting to the UE first information indicating a discontinuous reception, DRX, configuration of the access network node defining an active period in which the access network node is supposed to be active and configured to communicate with the UE and an inactive period in which the access network node is supposed to be inactive and configured not to communicate with the UE; transmitting a first downlink transmission to the UE in a first time slot; determining a second time slot, after said first time slot, in which the access network node expects to receive a non-acknowledgement, NACK, from the UE in a case where the first downlink transmission is not successfully received by the UE or an acknowledgement, ACK, from the UE in a case where the first downlink transmission is successfully received by the UE; checking if the second time slot overlaps with said inactive period; and in a case where the access network node will be in said inactive period during said second time slot, transmitting to the UE an indication of when the UE should transmit the ACK/NACK in a time slot that skips the inactive period. The indication may be transmitted to the UE in a downlink control channel.

The first time slot may corresponds to an SPS transmission occasion, in which case the method may further comprise maintaining the first downlink transmission in an HARQ buffer during the inactive period.

Alternatively, the first downlink transmission may comprise an SPS release command, in which case, the method may comprise transmitting the first downlink transmission in a downlink control channel.

The disclosure also provides a user equipment, UE, comprising: means for receiving first data of a first downlink transmission from an access network node; means for transmitting a non-acknowledgement, NACK, to the access network node in a case where the first downlink transmission is not successfully received; means for configuring a first timer indicating how long after transmitting the NACK to the access network node, the UE can expect to wait before receiving a retransmission of the downlink data transmission from the access network node; means for configuring a second timer that runs after the first timer and which indicates a time period over which the UE should be awake to receive the retransmission of the first downlink transmission from the access network node; means for receiving first information indicating a discontinuous transmission, DTX, configuration of the access network node defining an active period in which the access network node is supposed to be active and configured to communicate with the UE and an inactive period in which the access network node is supposed to be inactive and configured not to communicate with the UE; means for determining if the second timer in respect of the first downlink transmission overlaps with said inactive period of the access network node; and means for delaying starting of the second timer until the access network node is in the active period following the end of the inactive period, in a case where the second timer overlaps with the inactive period.

According to another aspect, the present disclosure provides a user equipment, UE, comprising: means for receiving first data of a first downlink transmission from an access network node; means for transmitting a non-acknowledgement, NACK, to the access network node in a case where the first downlink transmission is not successfully received; means for configuring a first timer indicating how long after transmitting the NACK to the access network node, the UE can expect to wait before receiving a retransmission of the downlink data transmission from the access network node; means for configuring a second timer that runs after the first timer and which indicates a time period over which the UE should be awake to receive the retransmission of the first downlink transmission from the access network node; means for receiving first information indicating a discontinuous transmission, DTX, configuration of the access network node defining an active period in which the access network node is supposed to be active and configured to communicate with the UE and an inactive period in which the access network node is supposed to be inactive and configured not to communicate with the UE; means for determining if the first timer in respect of the first downlink transmission is due to end during said inactive period of the access network node; and means for extending the first timer so that the first timer stops at the end of the inactive period in a case where the first timer is due to end within the inactive period.

According to another aspect, the present disclosure provides a user equipment, UE, comprising: means for receiving from an access network node a Semi-Persistent Scheduling, SPS, configuration that defines a plurality of downlink transmission occasions in which the access network node can transmit downlink data to the UE; means for receiving first information indicating a discontinuous transmission, DTX, configuration of the access network node defining an active period in which the access network node is supposed to be active and configured to communicate with the UE and an inactive period in which the access network node is supposed to be inactive and configured not to communicate with the UE; means for determining from the SPS configuration and said first information, if the access network node is in said inactive period during any time slot configured for an SPS downlink transmission; and means for skipping the monitoring of a downlink channel in a time slot that is configured for an SPS downlink transmission in a case where the access network node is in said inactive period during said time slot, unless the UE receives an indication from the access network node that the UE should monitor the downlink channel for that time slot.

According to another aspect, the present disclosure provides a user equipment, UE, comprising: means for receiving from an access network node a Semi-Persistent Scheduling, SPS, configuration that defines a plurality of downlink transmission occasions in which the access network node can transmit downlink data to the UE; means for receiving first information indicating a discontinuous reception, DRX, configuration of the access network node defining an active period in which the access network node is supposed to be active and configured to communicate with the UE and an inactive period in which the access network node is supposed to be inactive and configured not to communicate with the UE; means for receiving first data of a first downlink transmission transmitted by the access network node in a first time slot; means for determining a second time slot, after said first time slot, in which to transmit a non-acknowledgement, NACK, to the access network node in a case where the first downlink transmission is not successfully received, or an acknowledgement, ACK, to the access network node in a case where the first downlink transmission is successfully received; means for checking if the second time slot overlaps with said inactive period; and means for delaying, in a case where the access network node is in said inactive period during said second time slot, sending of the ACK/NACK to a third time slot that is after the second time slot and that overlaps with the active period of the access network node.

According to another aspect, the present disclosure provides a user equipment, UE, comprising: means for receiving from an access network node a Semi-Persistent Scheduling, SPS, configuration that defines a plurality of downlink transmission occasions in which the access network node can transmit downlink data to the UE; means for receiving first information indicating a discontinuous reception, DRX, configuration of the access network node defining an active period in which the access network node is supposed to be active and configured to communicate with the UE and an inactive period in which the access network node is supposed to be inactive and configured not to communicate with the UE; means for receiving first data of a first downlink transmission transmitted by the access network node in a first time slot; means for determining a second time slot, after said first time slot, in which to transmit a non-acknowledgement, NACK, to the access network node in a case where the first downlink transmission is not successfully received or an acknowledgement, ACK, to the access network node in a case where the first downlink transmission is successfully received; means for receiving from the access network node, in a case where the access network node will be in said inactive period during said second time slot, an indication of when the UE should transmit the ACK/NACK in a time slot that skips the inactive period.

According to another aspect, the present disclosure provides an access network node comprising: means for transmitting first data of a first downlink transmission to a User Equipment, UE; means for receiving a non-acknowledgement, NACK, from the UE in a case where the first downlink transmission is not successfully received; means for transmitting first configuration data to the UE for configuring a first timer that indicates how long after transmitting the NACK to the access network node, the UE can expect to wait before the access network node retransmits the first downlink transmission to the UE; means for transmitting second configuration data to the UE for configuring a second timer that runs after the first timer and which indicates a time period over which the UE should be awake to receive the retransmission of the first downlink transmission from the access network node; means for transmitting third configuration data indicating a discontinuous transmission, DTX, configuration of the access network node defining an active period in which the access network node is supposed to be active and configured to communicate with the UE and an inactive period in which the access network node is supposed to be inactive and configured not to communicate with the UE; means for determining if the first timer in respect of the first downlink transmission stops within the inactive period or if the second timer in respect of the first downlink transmission overlaps with said inactive period; and means for delaying retransmitting the first data transmission until the access network node is in the active period following the end of the inactive period in a case where the first downlink transmission stops within the inactive period or the second timer overlaps with the inactive period.

According to another aspect, the present disclosure provides an access network node comprising: means for transmitting to a User Equipment a Semi-Persistent Scheduling, SPS, configuration that defines a plurality of downlink transmission occasions in which the access network node can transmit downlink data to the UE; means for transmitting first information indicating a discontinuous transmission, DTX, configuration of the access network node defining an active period in which the access network node is supposed to be active and configured to communicate with the UE and an inactive period in which the access network node is supposed to be inactive and configured not to communicate with the UE; means for determining from the SPS configuration and said first information, if the access network node is in said inactive period during a time slot configured for an SPS downlink transmission to the UE; and means for transmitting, in the case where the access network node will transmit a downlink transmission to the UE during said inactive period, an indication to the UE that the UE should monitor the downlink channel for that time slot.

According to another aspect, the present disclosure provides an access network node comprising: means for transmitting to a user equipment, UE, a Semi-Persistent Scheduling, SPS, configuration that defines a plurality of downlink transmission occasions in which the access network node can transmit downlink data to the UE; means for transmitting to the UE first information indicating a discontinuous reception, DRX, configuration of the access network node defining an active period in which the access network node is supposed to be active and configured to communicate with the UE and an inactive period in which the access network node is supposed to be inactive and configured not to communicate with the UE; means for transmitting a first downlink transmission to the UE in a first time slot; means for determining a second time slot, after said first time slot, in which the access network node expects to receive a non-acknowledgement, NACK, from the UE in a case where the first downlink transmission is not successfully received by the UE or an acknowledgement, ACK, from the UE in a case where the first downlink transmission is successfully received by the UE; means for checking if the second time slot overlaps with said inactive period; and means for maintaining said first downlink transmission in an HARQ buffer until a third time slot that is after the second time slot and that overlaps with the active period of the access network node, in a case where the access network node is in said inactive period during said second time slot.

According to another aspect, the present disclosure provides an access network node comprising: means for transmitting to a user equipment, UE, a Semi-Persistent Scheduling, SPS, configuration that defines a plurality of downlink transmission occasions in which the access network node can transmit downlink data to the UE; means for transmitting to the UE first information indicating a discontinuous reception, DRX, configuration of the access network node defining an active period in which the access network node is supposed to be active and configured to communicate with the UE and an inactive period in which the access network node is supposed to be inactive and configured not to communicate with the UE; means for transmitting a first downlink transmission to the UE in a first time slot; means for determining a second time slot, after said first time slot, in which the access network node expects to receive a non-acknowledgement, NACK, from the UE in a case where the first downlink transmission is not successfully received by the UE or an acknowledgement, ACK, from the UE in a case where the first downlink transmission is successfully received by the UE; means for checking if the second time slot overlaps with said inactive period; and means for transmitting to the UE, in a case where the access network node will be in said inactive period during said second time slot, an indication of when the UE should transmit the ACK/NACK in a time slot that skips the inactive period.

The various functional means defined above that are part of the UE may be provided by a memory and one or more processors that execute instructions stored in the memory. Similarly, the various functional means defined above that are part of the access network node may be provided by a memory and one or more processors that execute instructions stored in the memory.

The disclosure may also provide a computer program product comprising computer implementable instructions for causing a programmable computer to carry out the method of any of the aspects described above. The computer implementable instructions may be provided as a signal or on a tangible computer readable medium.

### BRIEF DESCRIPTION OF DRAWINGS

Example embodiments of the disclosure will now be described, by way of example, with reference to the accompanying drawings in which:

FIG. 1 schematically illustrates a mobile (‘cellular’ or ‘wireless’) telecommunication system;

FIG. 2 illustrates a typical frame structure that may be used in the telecommunication system of FIG. 1;

FIG. 3 illustrates a typical resource grid that may be used in the telecommunication system of FIG. 1;

FIG. 4 illustrates an example of a DRX cycle or pattern;

FIG. 5 illustrates a HARQ feedback process for a downlink data transmission;

FIG. 6 illustrates a problem with the HARQ feedback process illustrated in FIG. 5 when a base station is in an inactive period;

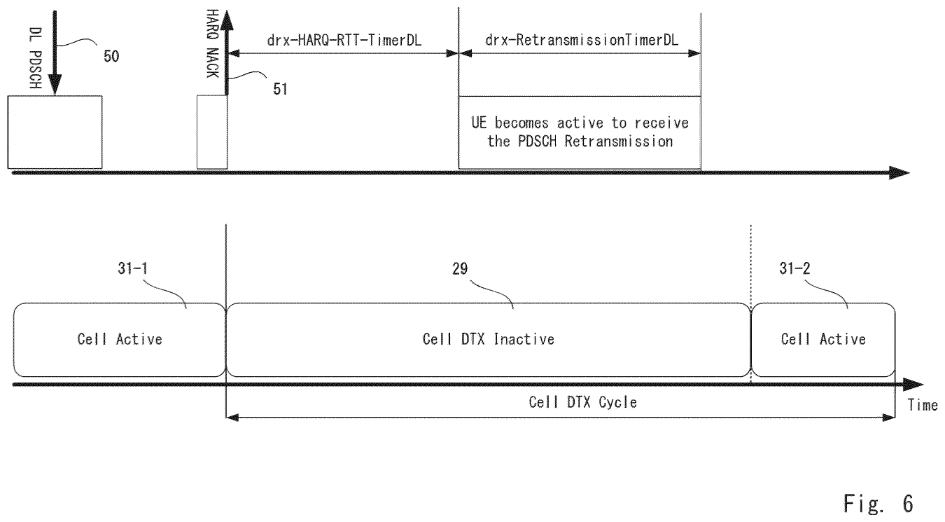

FIG. 7 illustrates a way to address the problem illustrated in FIG. 6;

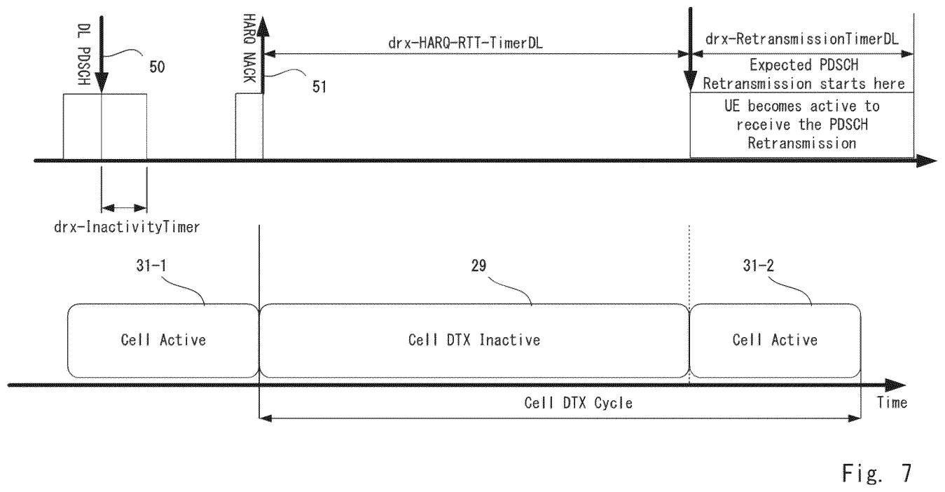

FIG. 8 illustrates a situation where a cell may be in an inactive period whilst a UE waiting for a downlink retransmission;

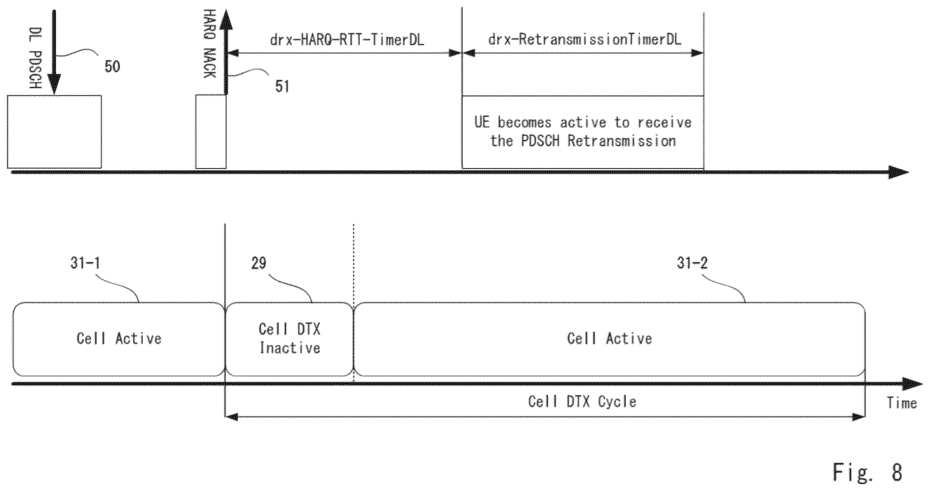

FIG. 9 illustrates a problem when an SPS transmission opportunity overlaps with a cell inactive period;

FIG. 10 illustrates a situation where an uplink acknowledgement for an SPS downlink transmission overlaps with a cell inactive period;

FIG. 11 illustrates a situation where an uplink acknowledgement for an SPS Release command overlaps with a cell inactive period;

FIG. 12 illustrates a situation where a cell may be in an inactive period whilst a UE waiting to transmit an uplink acknowledgement for a downlink SPS Release command;

FIG. 13 is a schematic block diagram illustrating the main components of a UE for the telecommunication system of FIG. 1; and

FIG. 14 is a schematic block diagram illustrating the main components of a base station for the telecommunication system of FIG. 1.

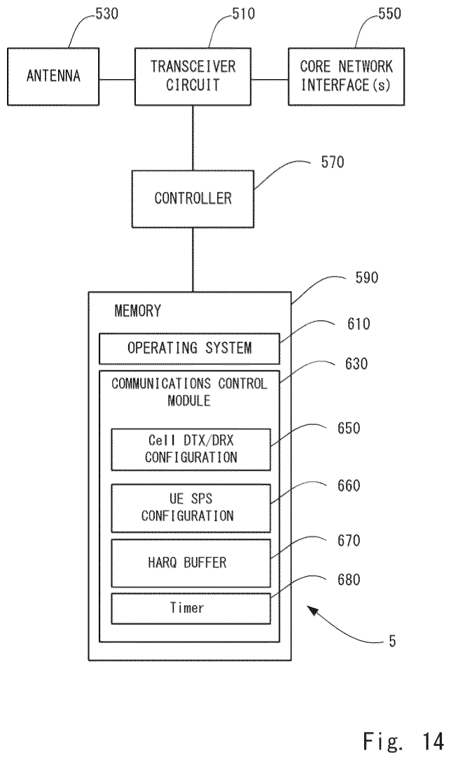

### DESCRIPTION OF EMBODIMENTS

### Overview

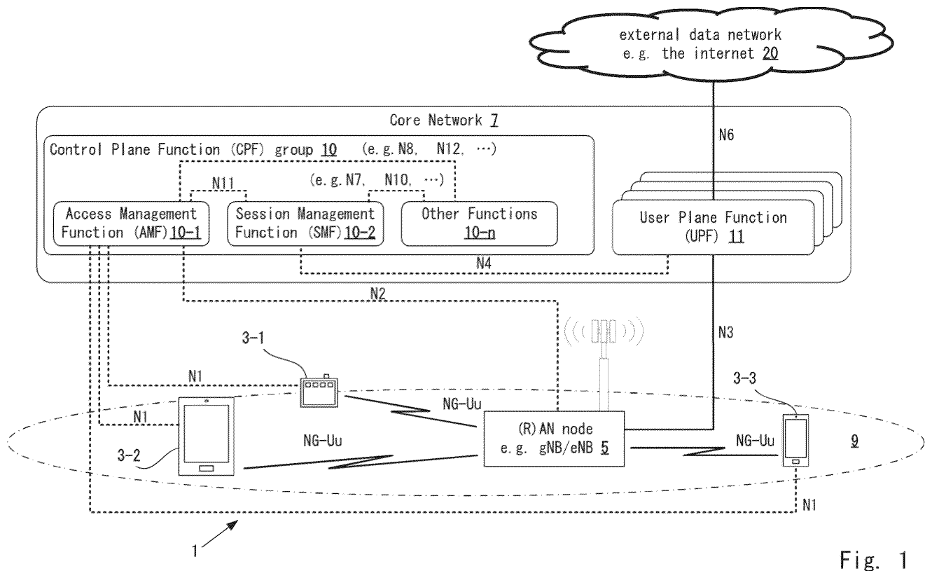

An exemplary telecommunication system will now be described in general terms, by way of example only, with reference to FIGS. 1, 2 and 3.

FIG. 1 schematically illustrates a mobile (‘cellular’ or ‘wireless’) telecommunication system 1 (e.g. communication system 1) to which example embodiments of the present disclosure are applicable.

In the communication system 1 user equipment (UEs) 3-1, 3-2, 3-3 (e.g. mobile telephones and/or other mobile or stationary devices) can communicate with each other via a radio access network (RAN) node 5 that operates according to one or more compatible radio access technologies (RATs). In the illustrated example, the RAN node 5 comprises a NR/5G base station or ‘gNB’ 5 operating one or more associated cells 9. Communication via the base station 5 is typically routed through a core network 7 (e.g. a 5G core network or evolved packet core network (EPC)).

As those skilled in the art will appreciate, whilst three UEs 3 and one base station 5 are shown in FIG. 1 for illustration purposes, the system, when implemented, will typically include other base stations 5 and UEs 3.

Each base station 5 controls one or more associated cells 9 either directly, or indirectly via one or more other nodes (such as home base stations, relays, remote radio heads, distributed units, and/or the like). It will be appreciated that the base stations 5 may be configured to support 4G, 5G, 6G, and/or any other 3GPP or non-3GPP communication protocols.

The UEs 3 and their serving base station 5 are connected via an appropriate air interface (for example the so-called ‘Uu’ interface and/or the like). Neighbouring base stations 5 may be connected to each other via an appropriate base station to base station interface (such as the so-called ‘X2’ interface, ‘Xn’ interface and/or the like).

The core network 7 includes a number of logical nodes (or ‘functions’) for supporting communication in the communication system 1. In this example, the core network 7 comprises control plane functions (CPFs) 10 and one or more user plane functions (UPFs) 11. The CPFs 10 include one or more Access and Mobility Management Functions (AMFs) 10-1, one or more Session Management Functions (SMFs) 10-2 and a number of other functions 10-n.

The base station 5 is connected to the core network nodes via appropriate interfaces (or ‘reference points’) such as an N2 reference point between the base station 5 and the AMF 10-1 for the communication of control signalling, and an N3 reference point between the base station 5 and each UPF 11 for the communication of user data. The UEs 3 are each connected to the AMF 10-1 via a logical non-access stratum (NAS) connection over an N1 reference point (analogous to the S1 reference point in LTE). It will be appreciated that N1 communications are routed transparently via the base station 5.

One or more UPFs 11 are connected to an external data network 20 (e.g. an IP network such as the internet) via reference point N6 for communication of the user data.

The AMF 10-1 performs mobility management related functions, maintains the NAS signalling connection with each UE 3 and manages UE registration. The AMF 10-1 is also responsible for managing paging. The SMF 10-2 provides session management functionality (that formed part of MME functionality in LTE) and additionally combines some control plane functions (provided by the serving gateway and packet data network gateway in LTE). The SMF 10-2 also allocates IP addresses to each UE 3.

The base station 5 of the communication system 1 is configured to operate at least one cell 9 on an associated TDD carrier that operates in unpaired spectrum. It will be appreciated that the base station 5 may also operate at least one cell 9 on an associated FDD carrier that operates in paired spectrum.

The base station 5 is also configured for transmission of, and the UEs 3 are configured for the reception of, control information and user data via a number of downlink (DL) physical channels. The DL physical channels correspond to resource elements (REs) carrying information originated from a higher layer. The physical channels may include, for example, a physical downlink shared channel (PDSCH), a physical broadcast channel (PBCH), and a physical downlink control channel (PDCCH). The PDSCH carries data sharing the PDSCH's capacity on a time and frequency basis. The PDSCH can carry a variety of items of data including, for example, user data, UE-specific higher layer control messages mapped down from higher channels, system information blocks (SIBs), and paging. The PDCCH carries downlink control information (DCI) for supporting a number of functions including, for example, scheduling the downlink transmissions on the PDSCH and also the uplink data transmissions on a physical uplink shared channel (PUSCH). The PBCH provides UEs 3 with the Master Information Block, MIB. It also, in conjunction with the PDCCH, supports the synchronisation of time and frequency, which aids cell acquisition, selection and re-selection.

The base station 5 also transmits DL physical signals that do not carry any data, such as, for example, reference signals (RSs) and synchronization signals (SSs). A reference signal (sometimes known as a pilot signal) is a signal with a predefined special waveform known to both the UE 3 and the base station 5. The reference signals may include, for example, cell specific reference signals, UE-specific reference signal (UE-RS), downlink demodulation signals (DMRS), and channel state information reference signal (CSI-RS).

Similarly, the UEs 3 are configured for transmission of, and the base station 5 is configured for the reception of, control information and user data via a number of uplink (UL) physical channels corresponding to REs carrying information originated from a higher layer, and UL physical signals which are used in the physical layer and correspond to REs which do not carry information originated from a higher layer. The physical channels may include, for example, the PUSCH, a physical uplink control channel (PUCCH), and/or a physical random-access channel (PRACH). The UL physical signals may include, for example, demodulation reference signals (DMRS) for an UL control/data signal, and/or sounding reference signals (SRS) used for UL channel measurement.

### Frame Structure

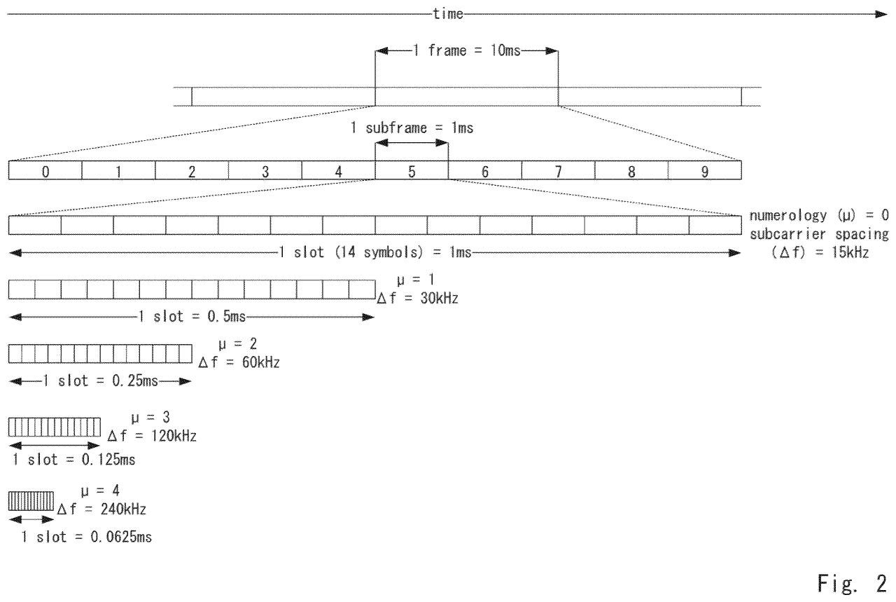

Referring to FIG. 2, which illustrates the typical frame structure that may be used in the communication system 1, the base station 5 and UEs 3 of the communication system 1 communicate with one another using resources that are organised, in the time domain, into frames in this case of length 10 ms. Each frame comprises ten equally sized subframes of 1 ms length. Each subframe is divided into one or more slots comprising 14 (or in some cases 12) orthogonal frequency-division multiplexing (OFDM) symbols of equal length.

As seen in FIG. 2, the communication system 1 supports multiple different numerologies (subcarrier spacing (SCS), slot lengths and hence OFDM symbol lengths). Specifically, each numerology is identified by a parameter, μ, where μ=0 represents 15 kHz (corresponding to the LTE SCS). Currently, the SCS for other values of μ can, in effect, be derived from μ=by scaling up in powers of 2 (i.e. SCS=15×2μ kHz). The relationship between the parameter, μ, and SCS (Δf) is as shown in Table 1:

TABLE 1
5G Numerology

| | | Number of slots | |
|---|---|---|---|
| μ | Δf = 2^{μ} · 15[kHz] | per subframe | Slot length (ms) |
| 0 | 15 | 1 | 1 |
| 1 | 30 | 2 | 0.5 |
| 2 | 60 | 4 | 0.25 |
| 3 | 120 | 8 | 0.125 |
| 4 | 240 | 16 | 0.0625 |

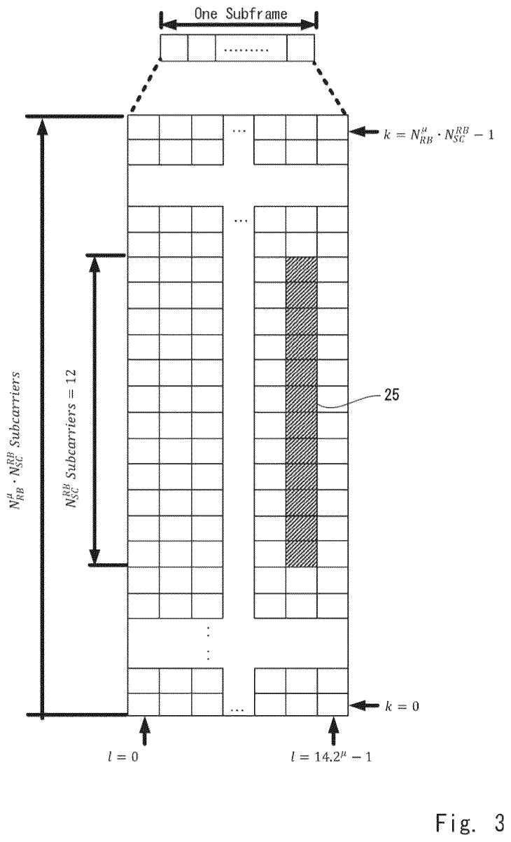

FIG. 3 illustrates the resource grid of a subframe shown in FIG. 2. As shown, the subcarrier spacing, the number of OFDM symbols within a subframe varies depending on the numerology. A single block shown in FIG. 3 corresponds to a single Resource Element and this is the smallest unit of the resource grid and is made up of one subcarrier in the frequency domain and one OFDM symbol in the time domain. A Resource Block 25 is defined only for the frequency domain and is defined as twelve consecutive subcarriers in the frequency domain in one OFDM symbol.

### DTX/DRX

A UE 3 may be configured to operate using a discontinuous reception (DRX) method. In a DRX method, the UE 3 is configured with a DRX configuration that includes a DRX pattern and a periodicity (DRX cycle) and optionally a number of DRX cycles. The DRX pattern defines “ON durations” in which the UE 3 is configured for receiving transmissions and “OFF durations” in which the UE 3 is not configured for receiving transmissions (e.g. transmissions from a base station 5). During the OFF durations the physical layer processing may be turned off within the UE 3. Advantageously, the energy consumption of the UE 3 is reduced in the periods in which the UE 3 is not configured for receiving transmissions.

The UE 3 is typically provided with its DRX configuration by or via the base station 5. A DRX configuration provided to the UE 3 (for example, using a DRX configuration information element (IE) included in a transmission from the base station 5 to the UE 3) may include, as mentioned above, an indication of a time period (OFF duration) for which the UE 3 is to be configured in a state in which the UE 3 does not receive and decode downlink transmissions, and an indication of a time period (ON duration) for which the UE 3 is to be configured for receiving downlink transmissions (e.g. a multicast or unicast transmission from the base station 5). The DRX configuration may also include a time offset, which may be useful for controlling the relative timing of the DRX configurations of different UEs 3 (e.g. to synchronise or offset the DRX patterns). The DRX configuration may also include an indication of a time period in which the UE is to remain configured for receiving transmissions following the reception of a PDCCH.

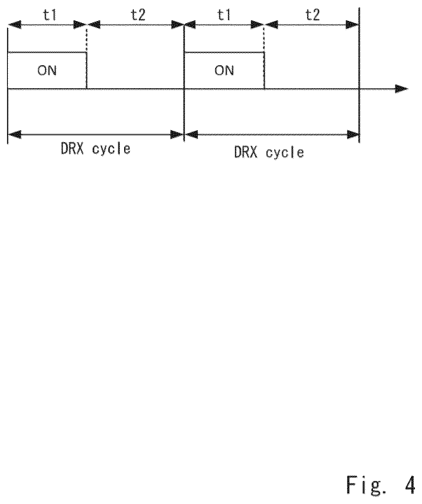

The ON duration may also be referred to as the ‘DRX active time’, and the OFF duration may also be referred to as a ‘sleep period’, or a ‘DRX inactive time’. An example of a DRX pattern having an ON duration of t1, and an OFF duration of t2, and which is repeated in accordance with a DRX cycle is illustrated in FIG. 4.

DRX may be configured per UE 3 by the network (e.g. via any suitable signalling from the base station 5). For example, the timing and/or duration of the ON durations in the DRX cycle may be different for different UEs 3. During the OFF durations, the UE 3 may be configured to not monitor a PDCCH, but may initiate an uplink transmission based on configured resources (for example, using a PUCCH, a random access channel (RACH), scheduling request (SR) or a configured grant PUSCH (CG-PUSCH)). During an OFF duration, the system may be configured for no transmission/reception between the UE 3 and the base station 5 in a corresponding cell. The base station 5 may nevertheless be configured for reduced or limited transmission/reception in the cell during the OFF duration of the DRX cycle. For example, the base station 5 may be configured to transmit only a subset of periodic signals or channels, such as common channels/signals or UE-specific channels/signals that would normally be transmitted in the cell.

DRX may be used when the UE 3 is in an RRC idle mode or when the UE 3 is in an RRC connected mode. For example, DRX may be used when the UE 3 is in an RRC idle mode to control the monitoring of paging messages transmitted by the base station 5. This advantageously prevents the UE 3 from monitoring all of the PDCCH transmission opportunities, thereby reducing the energy usage of the UE 3. Similarly, DRX may be used when the UE 3 is in the RRC connected state (referred to as C-DRX) to reduce the energy usage of the UE 3, for example by configuring periods in which the UE 3 is not required to monitor a PDCCH.

Within a C-DRX cycle, when the UE 3 is in an RRC connected state, the UE 3 periodically monitors the PDCCH during the ON durations, and does not monitor PDCCH outside of the ON durations (i.e. in the DRX inactive periods), thereby beneficially reducing the power consumption of the UE 3. Currently, during a C-DRX inactive time, the UE 3 is allowed to initiate an uplink transmission based on configured resources (for example, using a PUCCH, a random access channel (RACH), scheduling request (SR) or on a configured grant PUSCH (CG-PUSCH)).

A DRX configuration may also include a long DRX cycle in which the time between the ON durations is relatively large (t2 shown in FIG. 4 is relatively large), and a short DRX cycle in which the time between the ON durations is relatively small (t2 shown in FIG. 4 is relatively small). Whilst the long DRX cycle improves the energy efficiency of the system (because the overall percentage of time in which the UE 3 is in the ON state is smaller), latency of communications may be increased because the base station 5 cannot communicate with the UE 3 via downlink transmissions when the UE 3 is in the sleep state (the DRX inactive state). When the UE 3 is configured to use DRX after a period of inactivity following a data transfer, the UE 3 may be configured to initially use the short DRX cycle configuration, and after a further period of time (which may be defined by a Short DRX Cycle timer) the UE 3 may then operate using the long DRX cycle configuration. The short and long DRX configurations may be indicated to the UE 3, for example, using any suitable signalling from the base station 5 (or alternatively could be preconfigured in the UE 3).

Whilst DRX has been described above with reference to discontinuous reception performed by the UE 3, a similar DTX pattern can be defined to control the discontinuous transmission of data by the UE 3. When defined, the UE DTX pattern typically overlaps with the UE DRX pattern-so that when the UE 3 is not receiving data it is also normally not transmitting data.

As mentioned above, a base station 5 may also operate one or more of its cells in a DTX/DRX mode in substantially the same way as UE DTX/DRX-stopping the base station's transmissions and receptions during periods of time (OFF duration) when the base station 5 is inactive or asleep and resuming transmissions and receptions with the UEs 3 during periods of time (ON duration) when the base station 5 is active. The cell DTX/DRX configuration can be defined by a number of parameters such as the periodicity (DRX cycle), the start slot/offset, the ON duration (t1), the OFF duration (t2) and the number of cycles etc. as shown in FIG. 4.

### Semi Persistent Scheduling

As discussed in above, normally when the base station 5 wishes to transmit downlink data to the UE 3, the base station 5 must inform the UE 3 of the downlink resources (resource blocks 25) on which the base station 5 will transmit downlink data to the UE. Typically, the base station 5 informs the UE 3 that it has downlink data to be transmitted using downlink control information (DCI) that identifies the specific time-frequency resource blocks 25 within the Physical Downlink Shared Channel (PDSCH) that will be used to transmit the downlink data to the UE 3. However, this process is quite intensive for the physical and MAC layers of the base station 5 as it has to schedule and transmit such resource allocation data for each UE 3 that it is serving in each time slot that will carry downlink data for a UE 3. To reduce this burden on the physical and MAC layers of the base station 5, UEs can be configured with Semi Persistent Scheduling (SPS) at the RRC layer which defines specific resource blocks 25 that will be used periodically to carry downlink data for the UE 3. Once configured, the base station 5 simply has to activate those SPS resources whenever it is appropriate to do so. Once the data has been sent to the UE 3 and these regular SPS resources are no longer needed, the base station 5 can deactivate or release these SPS resources.

Once the base station 5 has transmitted downlink data to the UE 3, the UE 3 is configured to send an acknowledgment to confirm either successful receipt or to confirm that the data was not received correctly and effectively thereby requesting retransmission of the downlink data. In this case, the base station 5 and the UE 3 are configured for a downlink retransmission of the data at a set time period after the UE 3 has indicated unsuccessful reception of the downlink data. This gives the base station 5 time to arrange the retransmission and allows the UE 3 to enter its own DRX inactive period until it is time for it to be ready for the downlink retransmission.

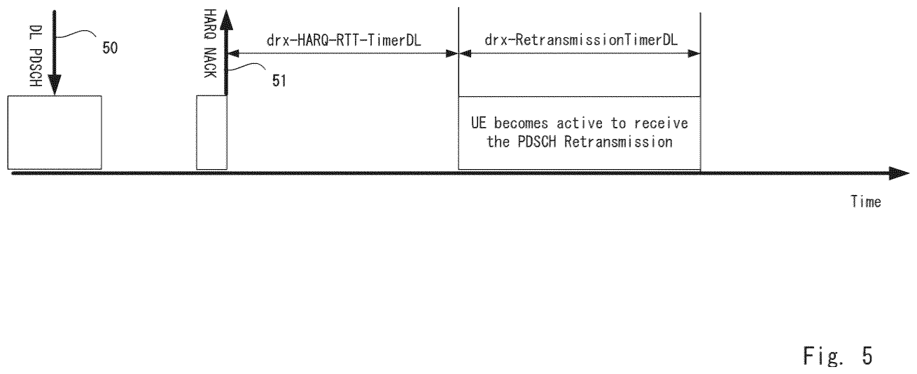

FIG. 5 illustrates this downlink retransmission process. When a downlink transport block 50 is erroneously received (CRC error), the UE 3 sends an HARQ NACK message 51 to the base station 5 and the base station 5 would then re-transmit the same packet again. The UE 3 would miss the re-transmission from the base station 5 if the UE 3 is not in an active state at the time of the re-transmission. However, being awake all the time until receiving the re-transmitted packet is also not power efficient for the UE.

Technically, the base station 5 could re-transmit the downlink packet at any time, but it is often done as soon as possible. Depending upon the network implementation and the HARQ round trip time, the network timing to re-transmit the downlink packet may vary from base station to base station. In order for UE 3 to be awake during the time of re-transmission and not before, two timers are defined in 3GPP. The first timer drx-HARQ-RTT-TimerDL (in number of symbols) defines after how long the UE can expect a downlink re-transmission from the base station 5. The UE 3 can be in a low power sleep state whilst this timer is running.

The second timer, drx-RetransmissionTimerDL (in number of slots), defines how long the UE 3 needs to be awake to receive the downlink retransmission. This second timer specifies the maximum number of slots for which the UE should be monitoring PDCCH when a re-transmission from the base station 5 is expected by the UE.

The UE should start drx-HARQ-RTT-TimerDL in the immediate first symbol after transmitting the NACK 51 in the UL. Once the drx-HARQ-RTT-TimerDL timer is expired, the UE starts the drx-Retransmission TimerDL timer in the next symbol and becomes active for the duration of this timer. As soon as the UE 3 detects a DL transmission for the corresponding HARQ process, the UE stops the timer drx-Retransmission TimerDL.

Overlap between Downlink Retransmission and Cell DTX

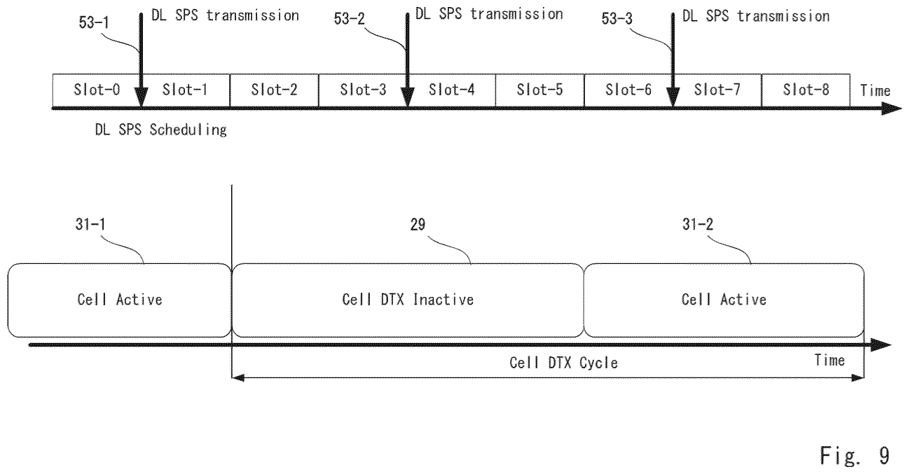

A further problem arises if the downlink resources scheduled for downlink data transmission by Semi Persistent Scheduling overlaps with a cell DTX inactive period 29. Such a scenario is illustrated in FIG. 9. Specifically, FIG. 9 illustrates three downlink SPS transmissions 53-1, 53-2 and 53-2, with downlink SPS transmission 53-2 overlapping with the cell DTX inactive period 29.

The inventors propose that in this situation, the base station 5 does not transmit downlink data during the cell DTX inactive period 29 so that the UE 3 does not need to monitor the Physical Downlink Control Channel (PDCCH) to monitor for the activation or deactivation of the SPS or the Physical Downlink Shared Channel (PDSCH) for a downlink transmission. However, there may be occasions where the opposite is desired. Accordingly, the inventors propose that the base station 5 broadcasts or configures the behaviour of all the UEs it is serving during cell DTX inactive periods-which may be to skip (or in the alternative to monitor) all downlink SPS and PDCCH transmissions during the cell DTX inactive period. Alternatively, before entering its cell DTX inactive period, the base station 5 may indicate to each UE 3 separately (via DCI signalling) which DL SPS occasions the UE 3 should monitor or skip during a cell DTX inactive period 29.

### Cell DRX Misalignment

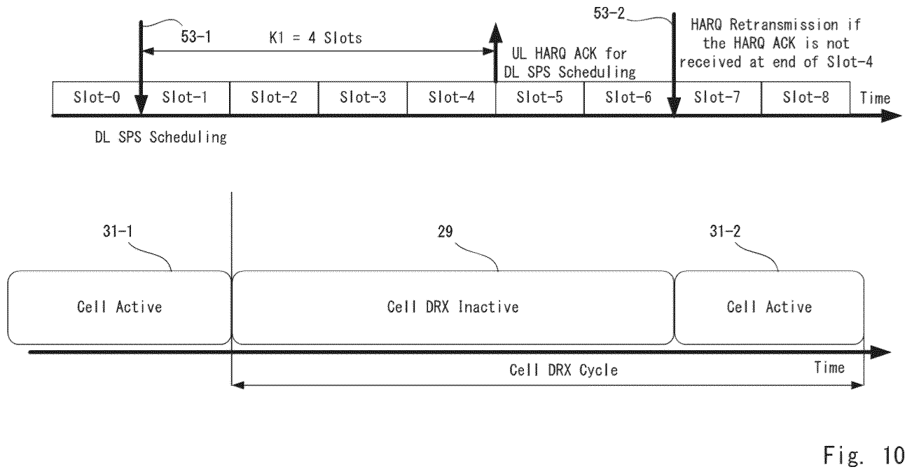

Some DL transmissions (for example DL SPS and SPS release messages) require the UE to send an acknowledgement (ACK) message on the Physical Uplink Control Channel (PUCCH) after a semi-statically configured number of slots. However, since DTX and DRX cycles can be configured independently within the base station 5, it cannot be precluded that a cell DRX inactive period 29 will happen shortly after a DL transmission that needs to be acknowledged by the UE and the base station 5 is in a cell DRX inactive period at the time that the UE is supposed to transmit the ACK message. An example illustrating this scenario is shown in FIG. 10.

Specifically, in Slot-0, the UE 3 receives a downlink SPS transmission 53-1 and is supposed to transmit an HARQ ACK/NACK 55 in slot 4. The next SPS transmission 53-2 is supposed to be transmitted in Slot-6 and is supposed to be a new downlink transmission if the Slot-0 transmission is acknowledged as being successfully received, otherwise it will be a retransmission of the SPS transmission 53-1 transmitted in Slot-0. In the illustrated scenario, however, the base station is in a cell DRX inactive period 29 during Slot-4 and the base station 5 does not expect an HARQ acknowledgement during its cell DRX inactive period. The inventors propose the following solutions to this problem:

### Option 1

The UE 3 autonomously updates the number of slots (K1) it has to wait before it transmits the HARQ ACK 55. Thus, before each HARQ ACK transmission 55, the UE 3 may be configured to: 1) check if the base station 5 is in the Cell DRX inactive period 29; and if it is 2) to check if the base station 5 is not receiving HARQ ACK transmissions. If both 1) and 2) are true, then the UE 3 restarts the number of waiting slots (K1) and does not flush its HARQ buffer. This UE 3 behaviour basically delays the UE 3's transmission of UL HARQ ACK. Then if a follow-up SPS transmission occasion also falls into the cell DRX inactive period (e.g., in slot 6 as shown in FIG. 10), that SPS transmission can be cancelled by the base station 5. However, if a follow-up SPS transmission occasion falls into the cell DRX active period (e.g., slot 7 as shown in FIG. 10), the base station 5 can either retransmit the previous non-acknowledged transmission (e.g., the transmission from slot 0 in FIG. 10) or schedule a resource to the UE 3 to allow the UE 3 to transmit its acknowledgement of that previously non-acknowledged transmission (e.g., from slot 0 shown in FIG. 10). Alternatively, a new K1 value (K1_{new}) can be set as K1_{new}=K1+T_{DRX} inactive (where T_{DRX_inactive} is the duration (in slots) of the cell DRX inactive period 29), provided that a high layer protocol does not ask the HARQ layer to drop the transmission block and flush the HARQ buffer. If there are multiple UEs that await to send UL HARQ feedback to the base station 5, following the above formula can help these UEs to stagger their uplink HARQ ACK transmissions to the base station 5 when the base station 5 transits from its DRX inactive period to its DRX active period. Otherwise, all UEs may send HARQ ACKs on the first available slot in the active period following the DRX inactive period.

### Option 2

The base station 5 indicates to the UE 3 the next HARQ ACK opportunity in order to skip the Cell DRX inactive period. In order to avoid an RRC reconfiguration of the UE 3, the delayed HARQ ACK opportunity can be provided by the base station 5 in DCI signalling at layers L1/L2.

In addition to performing Option 1 or Option 2 above, the base station 5 may be configured so that if no HARQ ACK 55 is received from the UE 3 (due to overlap with the cell DRX inactive period 29), the base station 5 skips one or more (re) transmissions over the next DL SPS occasion and waits for the UE's HARQ ACK 55 for the previous SPS transmission made before the base station 5 entered the cell DRX inactive period.

### Downlink SPS Release

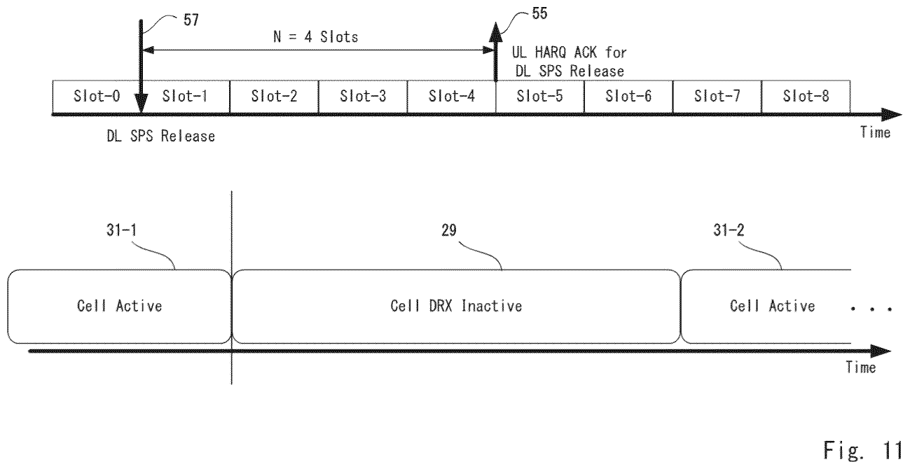

When the base station 5 decides it is time to stop the SPS resources being used by the UE 3 (for example when it has no more downlink data to send to the UE 3), the base station 5 will send an SPS release message to the UE 3. When the UE receives the SPS Release command, the UE 3 is supposed to provide an acknowledgement (UL ACK) to the base station 5 to confirm its reception within N slots of receiving the release. A similar problem to the one described above will happen if there is a cell DRX inactive period 29 during this N slots, as illustrated in FIG. 11.

Specifically, the base station 5 does not expect an HARQ ACK 55 of the SPS Release command 57 during the cell DRX inactive period 29, so the UE 3 needs to delay its HARQ ACK transmission 55 to the base station 5 to acknowledge the reception of the DL SPS Release command 57 until the base station 5 is available following the cell DRX inactive period 29. The inventors have proposed the following solutions to this problem:

### Option 1

The UE 3 autonomously updates its number of slots N it has to wait before the UE 3 transmits the HARQ ACK 55. Thus, before each HARQ ACK transmission, the UE 3 is configured to: 1) check if the base station 5 is in the cell DRX inactive period 29 and if it is, 2) it checks if the base station 5 is not receiving HARQ ACK transmission in this state, and if it does not, then the UE restarts the number of waiting slots (N) and does not flush its HARQ buffer. Alternatively, the UE 3 calculates the next opportunity for HARQ ACK transmission (following the Cell DRX inactive period T_{DRX_inactive}) and replaces the legacy value of N by N_{new}=N+T_{DRX_inactive} where T_{DRX_inactive} is the duration of the cell DRX inactive period 29 (in slots), provided that the L3 retransmission timer for the UE 3 does not expire by N_{new} slots.

Alternatively, if there are multiple HARQ ACK/NACKs (including from different transmission slots or multiple UEs) to be sent to the base station 5 at the start of the next cell DRX active period 31-2, multiple UEs may send the HARQ ACK/NACKs via multiplexing manner at the same transmission occasion depending on the network scheduling.

### Option 2

The base station 5 can indicate to the UE 3 the next HARQ ACK opportunity for acknowledging the SPS Release command 57 in order to skip the cell DRX inactive period 29. So, in the example shown in FIG. 11, N=7 can be included in the SPS Release command 57 instead of the default N=4. In this way, the UE 3 simply applies the new value (N=7) to work out when it should send the HARQ ACK 55 for the SPS Release command 57.

### Option 3

The base station 5 delays (or repeats) the transmission of the SPS Release command 57 to the UE 3 until the base station 5 is in the next DRX active period 31-2 for long enough. In the example of FIG. 11, this would involve delaying (or retransmitting) the SPS Release command 57 in slot 7 for the UE 3 to acknowledge receipt in slot 11 (not shown).

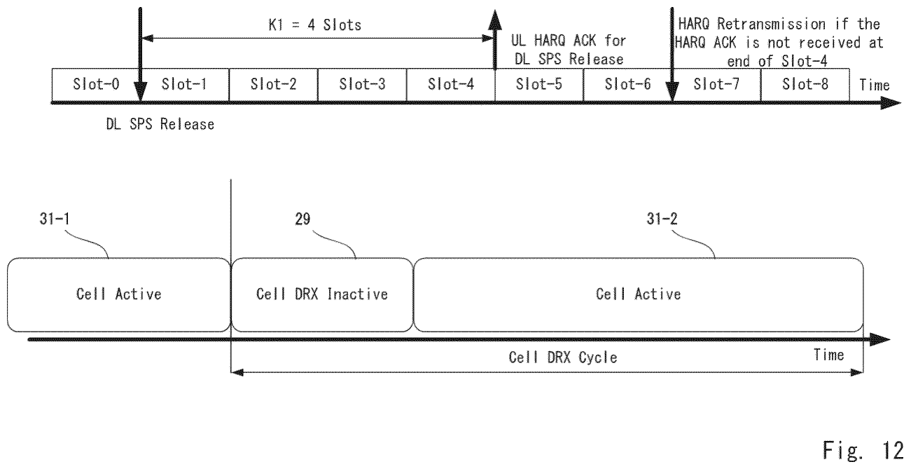

However, if as shown in FIG. 12, the cell DRX inactive period 29 is over by the time that the HARQ ACK 55 is due to be transmitted, then the UE can simply transmit the HARQ ACK 55 at the end of slot 4 in the normal way.

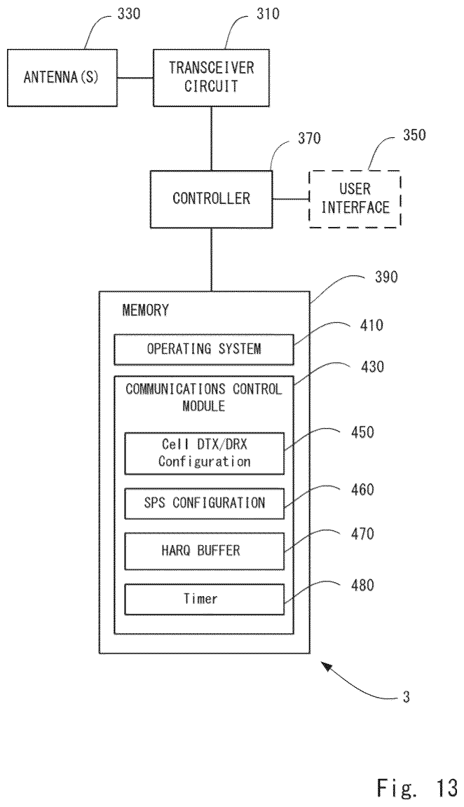

User Equipment FIG. 13 is a schematic block diagram illustrating the main components of a UE 3 as shown in FIG. 1.

As shown, the UE 3 has a transceiver circuit 310 that is operable to transmit signals to and to receive signals from a base station 5 via one or more antennas 330 (e.g., comprising one or more antenna elements). The UE 3 has a controller 370 to control the operation of the UE 3. The controller 370 is associated with a memory 390 and is coupled to the transceiver circuit 310. Although not necessarily required for its operation, the UE 3 might, of course, have all the usual functionality of a conventional UE 3 (e.g. a user interface 350, such as a touch screen/keypad/microphone/speaker and/or the like for, allowing direct control by and interaction with a user) and this may be provided by any one or any combination of hardware, software, and firmware, as appropriate. Software may be pre-installed in the memory 390 and/or may be downloaded via the communication system 1 or from a removable data storage device (RMD), for example.

The controller 370 is configured to control overall operation of the UE 3 by, in this example, program instructions or software instructions stored within memory 390. As shown, these software instructions include, among other things, an operating system 410, and a communications control module 430.

The communications control module 430 is operable to control the communication between the UE 3 and its one or more serving base stations 5 (and other communication devices connected to the base station 5, such as further UEs and/or core network nodes). The communications control module 430 is configured for the overall handling of uplink communications via associated uplink channels (e.g. via a physical uplink control channel (PUCCH), random access channel (RACH), and/or a physical uplink shared channel (PUSCH)) including both dynamic and semi-static signalling (e.g., SRS). The communications control module 430 is also configured for the overall handling of receipt of downlink communications via associated downlink channels (e.g. via a physical downlink control channel (PDCCH) and/or a physical downlink shared channel (PDSCH)) including both dynamic and semi-persistent scheduling (e.g., SPS). The communications control module 430 is responsible, for example: for determining where to monitor for downlink control information (e.g., the location of CSSs/USSs, CORESETs, and associated PDCCH candidates to monitor); for determining the resources to be used by the UE 3 for transmission/reception of UL/DL communications (including interleaved resources and resources subject to frequency hopping); for managing frequency hopping at the UE side; for determining how slots/symbols are configured (e.g., for UL, DL or SBFD communication, or the like); for determining which one or more bandwidth parts are configured for the UE 3; for determining how uplink transmissions should be encoded; for applying any SBFD specific communication configurations appropriately; and the like.

The communications control module 430 is configured to control communications in accordance with any of the proposals and options described for dealing with the overlapping of SPS resources and cell DTX/DRX inactive periods. The communications control module 430 includes a cell DRX/DTX configuration 450 which is provided by the serving base station 5 and identifies the cell DRX/DTX inactive and active periods. As those skilled in the art will appreciate, this information is needed by the UE to control its operation in accordance with the above proposals. The communications control module 430 also includes an SPS configuration 460 which defines the periodic resources that have been allocated to the UE 3 for downlink communications as well as the HARQ buffer 470 which the UE 3 uses to keep track of transmissions and base station acknowledgements, to control retransmissions and retransmission requests as part of the HARQ process. The communications control module 430 also includes various the various timer 480 used to define the timings discussed above.

### Base Station

FIG. 13 is a schematic block diagram illustrating the main components of the base station 5 for the communication system 1 shown in FIG. 1. As shown, the base station 5 has a transceiver circuit 510 for transmitting signals to and for receiving signals from the communication devices (such as UEs 3) via one or more antennas 530 (e.g. a single or multi-panel antenna array/massive antenna), and a core network interface 550 (e.g. comprising the N2, N3 and other reference points/interfaces) for transmitting signals to and for receiving signals from network nodes in the core network 7. Although not shown, the base station 5 may also be coupled to other base stations via an appropriate interface (e.g. the so-called ‘Xn’ interface in NR). The base station 5 has a controller 570 to control the operation of the base station 5. The controller 570 is associated with a memory 590. Software may be pre-installed in the memory 590 and/or may be downloaded via the communication system 1 or from a removable data storage device (RMD), for example. The controller 570 is configured to control the overall operation of the base station 5 by, in this example, program instructions or software instructions stored within memory 590.

As shown, these software instructions include, among other things, an operating system 610 and a communications control module 630.

The communications control module 630 is operable to control the communication between the base station 5 and UEs 3 and other network entities that are connected to the base station 5. The communications control module 630 is configured for the overall control of the reception and decoding of uplink communications, via associated uplink channels (e.g. via a physical uplink control channel (PUCCH), a random-access channel (RACH), and/or a physical uplink shared channel (PUSCH)) including both dynamic and semi-static signalling (e.g., SRS). The communications control module 630 is also configured for the overall control of the transmission of downlink communications via associated downlink channels (e.g. via a physical downlink control channel (PDCCH) and/or a physical downlink shared channel (PDSCH)) including both dynamic and semi-persistent scheduling (e.g. SPS). The communications control module 630 is responsible for managing full duplex (e.g., SBFD) communication including, where appropriate, the segregation of UL and DL communication via different physical antenna elements. The communications control module 630 is responsible, for example: for determining where to configure the UE 3 to monitor for downlink control information (e.g., the location of CSSs/USSs, CORESETs, and associated PDCCH candidates to monitor); for determining the resources to be scheduled for UE transmission/reception of UL/DL communications (including interleaved resources and resources subject to frequency hopping); for managing frequency hopping at the base station side; for configuring slots/symbols appropriately (e.g., for UL, DL or SBFD communication, or the like); for configuring one or more bandwidth parts for the UE 3; for providing related configuration signalling to the UE 3; and the like.

The communications control module 630 is configured to control communications with the UEs 3 in accordance with any of the proposals and options described above for allocating resources to the UEs to allow them to manage their downlink transmissions whilst the base station transitions between cell DTX/DRX inactive and active periods. The communications control module 630 includes a cell DRX/DTX configuration 650 which the base station broadcasts to UEs it is serving and is used by the base station 5 to define its cell DRX/DTX inactive and active periods. The communications control module 630 also includes UE SPS configuration 660 which defines the periodic semi persistent scheduling resources allocated to the different UEs that the base station is serving. The communications control module 630 also includes HARQ buffer 670 which the base station uses to keep track of transmissions and UE acknowledgements to control retransmissions and retransmission requests and timer 680 used to define the various timings discussed above. Specifically, the base station 5 also maintains the counters discussed above that the UE 3 runs in order to know when to expect ACK/NACK messages and when to transmit retransmissions to the UEs.

### Modifications and Alternatives

As those skilled in the art will appreciate, a number of modifications and alternatives can be made to the above example embodiments whilst still benefiting from the disclosure embodied therein.

As those skilled in the art will appreciate, the timing of the slots/SPS occasions shown in the figures relative to the timing of the cell DRX active and inactive periods is just given for explanation. In practice, the cell DRX inactive and active periods may span many SPS periods.

It will be appreciated, that whilst cellular communication generation (2G, 3G, 4G, 5G, 6G etc.) specific terminology may be used, in the interests of clarity, to refer to specific communication entities, the technical features described for a given entity are not limited to devices of that specific communication generation. The technical features may be implemented in any functionally equivalent communication entity regardless of any differences in the terminology used to refer to them.

In the above description, the UEs and the base station are described for ease of understanding as having a number of discrete functional components or modules. Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities.

In the above example embodiments, a number of software modules were described. As those skilled in the art will appreciate, the software modules may be provided in compiled or un-compiled form and may be supplied as a signal over a computer network, or on a recording medium. Further, the functionality performed by part, or all of this software may be performed using one or more dedicated hardware circuits. However, the use of software modules is preferred as it facilitates the updating of the base station or the UE in order to update their functionalities.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like. Various other modifications will be apparent to those skilled in the art and will not be described in further detail here.

The base station may comprise a ‘distributed’ base station having a central unit ‘CU’ and one or more separate distributed units (DUs).

The User Equipment (or “UE”, “mobile station”, “mobile device” or “wireless device”) in the present disclosure is an entity connected to a network via a wireless interface.

It should be noted that the present disclosure is not limited to a dedicated communication device and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.). A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyser, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table. This list is not exhaustive and is intended to be indicative of some examples of machine type communication applications.

| Service Area | MTC applications |
|---|---|
| Security | Surveillance systems |
| | Backup for landline |
| | Control of physical access (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote Maintenance/ | Sensors |
| Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an MVNO (Mobile Virtual Network Operator) service, an emergency radio communication system, a PBX (Private Branch exchange) system, a PHS/Digital Cordless Telecommunications system, a POS (Point of sale) system, an advertise calling system, an MBMS (Multimedia Broadcast and Multicast Service), a V2X (Vehicle to Everything) system, a train radio system, a location related service, a Disaster/Emergency Wireless Communication Service, a community service, a video streaming service, a femto cell application service, a VoLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and example embodiments described in the present document. Needless to say, these technical ideas and example embodiments are not limited to the above-described UE and various modifications can be made thereto.

Various other modifications will be apparent to those skilled in the art and will not be described in further detail here.

For example, the whole or part of the exemplary embodiments disclosed above can be described as, but not limited to, the following supplementary notes.

(Supplementary note 1)

A method performed by a user equipment, UE, the method comprising: receiving first data of a first downlink transmission from an access network node; in a case where the first downlink transmission is not successfully received, transmitting a non-acknowledgement, NACK, to the access network node;
configuring a first timer indicating how long after transmitting the NACK to the access network node, the UE can expect to wait before receiving a retransmission of the downlink data transmission from the access network node;
configuring a second timer that runs after the first timer and which indicates a time period over which the UE should be awake to receive the retransmission of the first downlink transmission from the access network node;
receiving first information indicating a discontinuous transmission, DTX, configuration of the access network node defining an active period in which the access network node is supposed to be active and configured to communicate with the UE and an inactive period in which the access network node is supposed to be inactive and configured not to communicate with the UE;
   determining if the second timer in respect of the first downlink transmission overlaps with said inactive period of the access network node; and
   in a case where the second timer overlaps with the inactive period, delaying starting of the second timer until the access network node is in the active period following the end of the inactive period.
      (Supplementary note 2)

The method according to supplementary note 1, wherein in a case where the first timer has started following the transmission of the NACK, extending the first timer so that the first timer stops at the end of the inactive period.

(Supplementary note 3)

The method according to supplementary note 1, wherein in a case where the first timer has not started following the transmission of the NACK, skipping the running of the first timer.

(Supplementary note 4)

A method performed by a user equipment, UE, the method comprising:
receiving first data of a first downlink transmission from an access network node;
in a case where the first downlink transmission is not successfully received, transmitting a non-acknowledgement, NACK, to the access network node;
configuring a first timer indicating how long after transmitting the NACK to the access network node, the UE can expect to wait before receiving a retransmission of the downlink data transmission from the access network node;
configuring a second timer that runs after the first timer and which indicates a time period over which the UE should be awake to receive the retransmission of the first downlink transmission from the access network node;
receiving first information indicating a discontinuous transmission, DTX, configuration of the access network node defining an active period in which the access network node is supposed to be active and configured to communicate with the UE and an inactive period in which the access network node is supposed to be inactive and configured not to communicate with the UE;
   determining if the first timer in respect of the first downlink transmission is due to end during said inactive period of the access network node; and
   in a case where the first timer is due to end within the inactive period, extending the first timer so that the first timer stops at the end of the inactive period.
      (Supplementary note 5)

A method performed by a user equipment, UE, the method comprising:
receiving from an access network node a Semi-Persistent Scheduling, SPS, configuration that defines a plurality of downlink transmission occasions in which the access network node can transmit downlink data to the UE;
receiving first information indicating a discontinuous transmission, DTX, configuration of the access network node defining an active period in which the access network node is supposed to be active and configured to communicate with the UE and an inactive period in which the access network node is supposed to be inactive and configured not to communicate with the UE;
determining from the SPS configuration and said first information, if the access network node is in said inactive period during any time slot configured for an SPS downlink transmission;
in the case where the access network node is in said inactive period during a time slot configured for an SPS downlink transmission skipping the monitoring of a downlink channel in said time slot unless the UE receives an indication from the access network node that the UE should monitor the downlink channel for that time slot.
   (Supplementary note 6)

The method according to supplementary note 5, wherein UE receives the indication from the access network node on a broadcast channel or in UE specific downlink control information.

(Supplementary note 7)

The method according to supplementary note 5 or 6, wherein the UE skips the monitoring of a downlink control channel and/or a downlink shared data channel.

(Supplementary note 8)

A method performed by a user equipment, UE, the method comprising:
receiving from an access network node a Semi-Persistent Scheduling, SPS, configuration that defines a plurality of downlink transmission occasions in which the access network node can transmit downlink data to the UE;
receiving first information indicating a discontinuous reception, DRX, configuration of the access network node defining an active period in which the access network node is supposed to be active and configured to communicate with the UE and an inactive period in which the access network node is supposed to be inactive and configured not to communicate with the UE;
   receiving first data of a first downlink transmission transmitted by the access network node in a first time slot;
in a case where the first downlink transmission is not successfully received, determining a second time slot, after said first time slot, in which to transmit a non-acknowledgement, NACK, to the access network node in a case where the first downlink transmission is not successfully received, or an acknowledgement, ACK, to the access network node in a case where the first downlink transmission is successfully received;
checking if the second time slot overlaps with said inactive period; and in a case where the access network node is in said inactive period during said second time slot, delaying sending of the ACK/NACK to a third time slot that is after the second time slot and that overlaps with the active period of the access network node.
   (Supplementary note 9)

The method according to supplementary note 8, wherein the second time slot is determined by adding a predefined number of slots to the first time slot and wherein the third time slot is determined by adding an integer multiple of said predetermined number of slots to said second time slot.

(Supplementary note 10)

The method according to supplementary note 9, wherein a counter is used to count the predefined number of slots and is restarted one or more times until the determined third time slot does not overlap with said inactive period.

(Supplementary note 11)

The method according to supplementary note 8, further comprising determining a duration of the inactive period in time slots, wherein the second time slot is determined by adding a predefined number of slots to the first time slot and wherein the third time slot is determined by adding the duration of the inactive period to the second time slot.

(Supplementary note 12)

A method performed by a user equipment, UE, the method comprising:
receiving from an access network node a Semi-Persistent Scheduling, SPS, configuration that defines a plurality of downlink transmission occasions in which the access network node can transmit downlink data to the UE;
receiving first information indicating a discontinuous reception, DRX, configuration of the access network node defining an active period in which the access network node is supposed to be active and configured to communicate with the UE and an inactive period in which the access network node is supposed to be inactive and configured not to communicate with the UE;
receiving first data of a first downlink transmission transmitted by the access network node in a first time slot;
determining a second time slot, after said first time slot, in which to transmit a non-acknowledgement, NACK, to the access network node in a case where the first downlink transmission is not successfully received or an acknowledgement, ACK, to the access network node in a case where the first downlink transmission is successfully received;
in a case where the access network node will be in said inactive period during said second time slot, receiving from the access network node an indication of when the UE should transmit the ACK/NACK in a time slot that skips the inactive period.
   (Supplementary note 13)

The method according to supplementary note 12, wherein the indication is received from the access network node in a downlink control channel.

(Supplementary note 14)

The method according to any one of supplementary notes 8 to 13, wherein the first time slot corresponds to an SPS transmission occasion.

(Supplementary note 15)

The method according to supplementary note 14, wherein in the case that the first downlink transmission is not successfully received, maintaining the first data in an HARQ buffer for use in decoding a subsequent retransmission of the first downlink transmission.

(Supplementary note 16)

The method according to any one of supplementary notes 8 to 13, wherein the first downlink transmission comprises an SPS release command.

(Supplementary note 17)

The method according to supplementary note 16, wherein the first downlink transmission is received in a downlink control channel.

(Supplementary note 18)

A method performed by an access network node, the method comprising: transmitting first data of a first downlink transmission to a User Equipment, UE; receiving a non-acknowledgement, NACK, from the UE in a case where the first downlink transmission is not successfully received;
transmitting first configuration data to the UE for configuring a first timer that indicates how long after transmitting the NACK to the access network node, the UE can expect to wait before the access network node retransmits the first downlink transmission to the UE;
transmitting second configuration data to the UE for configuring a second timer that runs after the first timer and which indicates a time period over which the UE should be awake to receive the retransmission of the first downlink transmission from the access network node;
transmitting third configuration data indicating a discontinuous transmission, DTX, configuration of the access network node defining an active period in which the access network node is supposed to be active and configured to communicate with the UE and an inactive period in which the access network node is supposed to be inactive and configured not to communicate with the UE;
   determining if the first timer in respect of the first downlink transmission stops within the inactive period or if the second timer in respect of the first downlink transmission overlaps with said inactive period; and
   in a case where the first downlink transmission stops within the inactive period or second timer overlaps with the inactive period, delaying retransmitting the first data transmission until the access network node is in the active period following the end of the inactive period.
      (Supplementary note 19)

A method performed by an access network node, the method comprising:
transmitting to a User Equipment a Semi-Persistent Scheduling, SPS, configuration that defines a plurality of downlink transmission occasions in which the access network node can transmit downlink data to the UE;
transmitting first information indicating a discontinuous transmission, DTX, configuration of the access network node defining an active period in which the access network node is supposed to be active and configured to communicate with the UE and an inactive period in which the access network node is supposed to be inactive and configured not to communicate with the UE;
determining from the SPS configuration and said first information, if the access network node is in said inactive period during a time slot configured for an SPS downlink transmission to the UE;
in the case where the access network node will transmit a downlink transmission to the UE during said inactive period, transmitting an indication to the UE that the UE should monitor the downlink channel for that time slot.
   (Supplementary note 20)

The method according to supplementary note 19, wherein the indication is transmitted to the UE on a broadcast channel or in UE specific downlink control information.

(Supplementary note 21)

A method performed by an access network node, the method comprising:
transmitting to a user equipment, UE, a Semi-Persistent Scheduling, SPS, configuration that defines a plurality of downlink transmission occasions in which the access network node can transmit downlink data to the UE;
transmitting to the UE first information indicating a discontinuous reception, DRX, configuration of the access network node defining an active period in which the access network node is supposed to be active and configured to communicate with the UE and an inactive period in which the access network node is supposed to be inactive and configured not to communicate with the UE;
transmitting a first downlink transmission to the UE in a first time slot;
determining a second time slot, after said first time slot, in which the access network node expects to receive a non-acknowledgement, NACK, from the UE in a case where the first downlink transmission is not successfully received by the UE or an acknowledgement, ACK, from the UE in a case where the first downlink transmission is successfully received by the UE;
checking if the second time slot overlaps with said inactive period; and
in a case where the access network node is in said inactive period during said second time slot, maintaining said first downlink transmission in an HARQ buffer until a third time slot that is after the second time slot and that overlaps with the active period of the access network node.
   (Supplementary note 22)

The method according to supplementary note 21, wherein the second time slot is determined by adding a predefined number of slots to the first time slot and wherein the third time slot is determined by adding an integer multiple of said predetermined number of slots to said second time slot.

(Supplementary note 23)

The method according to supplementary note 22, wherein a counter is used to count the predefined number of slots and is restarted one or more times until the determined third time slot does not overlap with said inactive period.

(Supplementary note 24)

The method according to supplementary note 21, wherein the second time slot is determined by adding a predefined number of slots to the first time slot and wherein the third time slot is determined by adding the duration of the inactive period to the second time slot.

(Supplementary note 25)

A method performed by an access network node, the method comprising:
transmitting to a user equipment, UE, a Semi-Persistent Scheduling, SPS, configuration that defines a plurality of downlink transmission occasions in which the access network node can transmit downlink data to the UE;
transmitting to the UE first information indicating a discontinuous reception, DRX, configuration of the access network node defining an active period in which the access network node is supposed to be active and configured to communicate with the UE and an inactive period in which the access network node is supposed to be inactive and configured not to communicate with the UE;
transmitting a first downlink transmission to the UE in a first time slot;
determining a second time slot, after said first time slot, in which the access network node expects to receive a non-acknowledgement, NACK, from the UE in a case where the first downlink transmission is not successfully received by the UE or an acknowledgement, ACK, from the UE in a case where the first downlink transmission is successfully received by the UE;
checking if the second time slot overlaps with said inactive period; and
in a case where the access network node will be in said inactive period during said second time slot, transmitting to the UE an indication of when the UE should transmit the ACK/NACK in a time slot that skips the inactive period.
   (Supplementary note 26)

The method according to supplementary note 25, wherein the indication is transmitted to the UE in a downlink control channel.

(Supplementary note 27)

The method according to any one of supplementary notes 21 to 26, wherein the first time slot corresponds to an SPS transmission occasion.

(Supplementary note 28)

The method according to supplementary note 27, further comprising maintaining the first downlink transmission in an HARQ buffer during the inactive period.

(Supplementary note 29)

The method according to any one of supplementary notes 21 to 26, wherein the first downlink transmission comprises an SPS release command.

(Supplementary note 30)

The method according to supplementary note 29, comprising transmitting the first downlink transmission in a downlink control channel.

(Supplementary note 31)

A user equipment, UE, comprising:
means for receiving first data of a first downlink transmission from an access network node;
means for transmitting a non-acknowledgement, NACK, to the access network node in a case where the first downlink transmission is not successfully received;
means for configuring a first timer indicating how long after transmitting the NACK to the access network node, the UE can expect to wait before receiving a retransmission of the downlink data transmission from the access network node;
means for configuring a second timer that runs after the first timer and which indicates a time period over which the UE should be awake to receive the retransmission of the first downlink transmission from the access network node;
means for receiving first information indicating a discontinuous transmission, DTX, configuration of the access network node defining an active period in which the access network node is supposed to be active and configured to communicate with the UE and an inactive period in which the access network node is supposed to be inactive and configured not to communicate with the UE;
   means for determining if the second timer in respect of the first downlink transmission overlaps with said inactive period of the access network node; and
   means for delaying starting of the second timer until the access network node is in the active period following the end of the inactive period, in a case where the second timer overlaps with the inactive period.
      (Supplementary note 32)

A user equipment, UE, comprising:
means for receiving first data of a first downlink transmission from an access network node;
means for transmitting a non-acknowledgement, NACK, to the access network node in a case where the first downlink transmission is not successfully received;
means for configuring a first timer indicating how long after transmitting the NACK to the access network node, the UE can expect to wait before receiving a retransmission of the downlink data transmission from the access network node;
means for configuring a second timer that runs after the first timer and which indicates a time period over which the UE should be awake to receive the retransmission of the first downlink transmission from the access network node; means for receiving first information indicating a discontinuous transmission, DTX, configuration of the access network node defining an active period in which the access network node is supposed to be active and configured to communicate with the UE and an inactive period in which the access network node is supposed to be inactive and configured not to communicate with the UE;
means for determining if the first timer in respect of the first downlink transmission is due to end during said inactive period of the access network node; and
means for extending the first timer so that the first timer stops at the end of the inactive period in a case where the first timer is due to end within the inactive period.
   (Supplementary note 33)

A user equipment, UE, comprising:
means for receiving from an access network node a Semi-Persistent Scheduling, SPS, configuration that defines a plurality of downlink transmission occasions in which the access network node can transmit downlink data to the UE;
means for receiving first information indicating a discontinuous transmission, DTX, configuration of the access network node defining an active period in which the access network node is supposed to be active and configured to communicate with the UE and an inactive period in which the access network node is supposed to be inactive and configured not to communicate with the UE;
means for determining from the SPS configuration and said first information, if the access network node is in said inactive period during any time slot configured for an SPS downlink transmission; and
means for skipping the monitoring of a downlink channel in a time slot that is configured for an SPS downlink transmission in a case where the access network node is in said inactive period during said time slot, unless the UE receives an indication from the access network node that the UE should monitor the downlink channel for that time slot.
   (Supplementary note 34)

A user equipment, UE, comprising:
means for receiving from an access network node a Semi-Persistent Scheduling, SPS, configuration that defines a plurality of downlink transmission occasions in which the access network node can transmit downlink data to the UE;
means for receiving first information indicating a discontinuous reception, DRX, configuration of the access network node defining an active period in which the access network node is supposed to be active and configured to communicate with the UE and an inactive period in which the access network node is supposed to be inactive and configured not to communicate with the UE;
means for receiving first data of a first downlink transmission transmitted by the access network node in a first time slot;
means for determining a second time slot, after said first time slot, in which to transmit a non-acknowledgement, NACK, to the access network node in a case where the first downlink transmission is not successfully received, or an acknowledgement, ACK, to the access network node in a case where the first downlink transmission is successfully received;
means for checking if the second time slot overlaps with said inactive period; and
means for delaying, in a case where the access network node is in said inactive period during said second time slot, sending of the ACK/NACK to a third time slot that is after the second time slot and that overlaps with the active period of the access network node.
   (Supplementary note 35)

A user equipment, UE, comprising:
means for receiving from an access network node a Semi-Persistent Scheduling, SPS, configuration that defines a plurality of downlink transmission occasions in which the access network node can transmit downlink data to the UE;
means for receiving first information indicating a discontinuous reception, DRX, configuration of the access network node defining an active period in which the access network node is supposed to be active and configured to communicate with the UE and an inactive period in which the access network node is supposed to be inactive and configured not to communicate with the UE;
means for receiving first data of a first downlink transmission transmitted by the access network node in a first time slot;
means for determining a second time slot, after said first time slot, in which to transmit a non-acknowledgement, NACK, to the access network node in a case where the first downlink transmission is not successfully received or an acknowledgement, ACK, to the access network node in a case where the first downlink transmission is successfully received;
means for receiving from the access network node, in a case where the access network node will be in said inactive period during said second time slot, an indication of when the UE should transmit the ACK/NACK in a time slot that skips the inactive period.
   (Supplementary note 36)

An access network node comprising:
means for transmitting first data of a first downlink transmission to a User Equipment, UE;
means for receiving a non-acknowledgement, NACK, from the UE in a case where the first downlink transmission is not successfully received;
means for transmitting first configuration data to the UE for configuring a first timer that indicates how long after transmitting the NACK to the access network node, the UE can expect to wait before the access network node retransmits the first downlink transmission to the UE;
means for transmitting second configuration data to the UE for configuring a second timer that runs after the first timer and which indicates a time period over which the UE should be awake to receive the retransmission of the first downlink transmission from the access network node;
means for transmitting third configuration data indicating a discontinuous transmission, DTX, configuration of the access network node defining an active period in which the access network node is supposed to be active and configured to communicate with the UE and an inactive period in which the access network node is supposed to be inactive and configured not to communicate with the UE;
   means for determining if the first timer in respect of the first downlink transmission stops within the inactive period or if the second timer in respect of the first downlink transmission overlaps with said inactive period; and
   means for delaying retransmitting the first data transmission until the access network node is in the active period following the end of the inactive period in a case where the first downlink transmission stops within the inactive period or the second timer overlaps with the inactive period.
      (Supplementary note 37)

An access network node comprising:
means for transmitting to a User Equipment a Semi-Persistent Scheduling, SPS, configuration that defines a plurality of downlink transmission occasions in which the access network node can transmit downlink data to the UE;
means for transmitting first information indicating a discontinuous transmission, DTX, configuration of the access network node defining an active period in which the access network node is supposed to be active and configured to communicate with the UE and an inactive period in which the access network node is supposed to be inactive and configured not to communicate with the UE;
means for determining from the SPS configuration and said first information, if the access network node is in said inactive period during a time slot configured for an SPS downlink transmission to the UE; and
means for transmitting, in the case where the access network node will transmit a downlink transmission to the UE during said inactive period, an indication to the UE that the UE should monitor the downlink channel for that time slot.
   (Supplementary note 38)

An access network node comprising:
means for transmitting to a user equipment, UE, a Semi-Persistent Scheduling, SPS, configuration that defines a plurality of downlink transmission occasions in which the access network node can transmit downlink data to the UE;
means for transmitting to the UE first information indicating a discontinuous reception, DRX, configuration of the access network node defining an active period in which the access network node is supposed to be active and configured to communicate with the UE and an inactive period in which the access network node is supposed to be inactive and configured not to communicate with the UE;
means for transmitting a first downlink transmission to the UE in a first time slot;
means for determining a second time slot, after said first time slot, in which the access network node expects to receive a non-acknowledgement, NACK, from the UE in a case where the first downlink transmission is not successfully received by the UE or an acknowledgement, ACK, from the UE in a case where the first downlink transmission is successfully received by the UE;
means for checking if the second time slot overlaps with said inactive period; and means for maintaining said first downlink transmission in an HARQ buffer until a third time slot that is after the second time slot and that overlaps with the active period of the access network node, in a case where the access network node is in said inactive period during said second time slot.
   (Supplementary note 39)

An access network node comprising:
means for transmitting to a user equipment, UE, a Semi-Persistent Scheduling, SPS, configuration that defines a plurality of downlink transmission occasions in which the access network node can transmit downlink data to the UE;
means for transmitting to the UE first information indicating a discontinuous reception, DRX, configuration of the access network node defining an active period in which the access network node is supposed to be active and configured to communicate with the UE and an inactive period in which the access network node is supposed to be inactive and configured not to communicate with the UE;
means for transmitting a first downlink transmission to the UE in a first time slot;
means for determining a second time slot, after said first time slot, in which the access network node expects to receive a non-acknowledgement, NACK, from the UE in a case where the first downlink transmission is not successfully received by the UE or an acknowledgement, ACK, from the UE in a case where the first downlink transmission is successfully received by the UE;
means for checking if the second time slot overlaps with said inactive period; and
means for transmitting to the UE, in a case where the access network node will be in said inactive period during said second time slot, an indication of when the UE should transmit the ACK/NACK in a time slot that skips the inactive period.

This application is based upon and claims the benefit of priority from Great Britain Patent Application No. 2305077.6, filed on Apr. 5, 2023, the disclosure of which is incorporated herein in its entirety by reference.

### REFERENCE SIGNS LIST

1 COMMUNICATION SYSTEM
3 USER EQUIPMENT
5 BASE STATION
7 CORE NETWORK
9 CELL
10 CONTROL PLANE FUNCTIONS
11 USER PLANE FUNCTIONS
20 EXTERNAL DATA NETWORK
310 TRANSCEIVER CIRCUIT
330 ANTENNA
350 USER INTERFACE
370 CONTROLLER
390 MEMORY
410 OPERATING SYSTEM
430 COMMUNICATIONS CONTROL MODULE
450 CELL DTX/DRX CONFIGURATION
460 SPS CONFIGURATION
470 HARQ BUFFER
480 TIMER
510 TRANSCEIVER CIRCUIT
530 ANTENNA
550 CORE NETWORK INTERFACE
570 CONTROLLER
590 MEMORY
610 OPERATING SYSTEM
630 COMMUNICATIONS CONTROL MODULE
650 CELL DTX/DRX CONFIGURATION
660 UE SPS CONFIGURATION
670 HARQ BUFFER
680 TIMER

What is claimed is:

1. A method performed by a user equipment (UE), the method comprising:
receiving, from an access network node, a first downlink transmission;
determining that a timing of a procedure related to the first downlink transmission overlaps a cell discontinuous transmission (DTX)/discontinuous reception (DRX) inactive period of the access network node; and
delaying or stopping starting the procedure related to the first downlink transmission.

2. The method according to claim 1, wherein
the delaying or stopping the starting the procedure related to the first downlink transmission is performed until the access network node is in a cell DTX/DRX active period following the end of the cell DTX/DRX inactive period.

3. The method according to claim 1, wherein
the determining is performed by determining that the timing of a duration of at least one of a drx-Retransmission timer or a drx-Hybrid Automatic Repeat Request (HARQ) Round Trip Time (RTT) TimerDownlink (DL) overlaps the cell DTX inactive period of the access network node,
in a case where data regarding the first downlink transmission was not successfully decoded, the delaying or stopping starting the drx-Retransmission timer.

4. The method according to claim 3, further comprising:
in a case where data regarding the first downlink transmission was not successfully decoded and the drx-HARQ-RTT-TimerDL has already started, stopping the drx-HARQ-RTT-TimerDL after an end of the cell DTX inactive period.

5. The method according to claim 3, further comprising:
in a case where data regarding the first downlink transmission was not successfully decoded and the drx-HARQ-RTT-TimerDL is not started, delaying starting the drx-HARQ-RTT-TimerDL until the access network node is in the cell DTX active period following the end of the cell DTX inactive period.

6. The method according to claim 3, further comprising:
receiving, from the access network node, information indicating to at least one of:
stop the drx-HARQ-RTT-TimerDL after an end of the cell DTX inactive period, or
start the drx-RetransmissionTimerDL after a start of the cell DTX active period.

7. The method according to claim 6, wherein
the information is received in a media access control control element.

8. The method according to claim 1, wherein
the first downlink transmission is one of a Downlink Semi Persistent Scheduling (SPS) transmission, and the method comprises:
in the case where a duration of a time slot configured for the Downlink SPS transmission overlaps the cell DTX inactive period, skipping monitoring a downlink channel in the time slot.

9. The method according to claim 8, further comprising:
receiving, from the access network node, information indicating whether the UE should skip or monitor downlink SPS transmissions and/or at least one physical downlink control channel in the cell DTX inactive period.

10. The method according to claim 9, wherein
the information is received in a broadcast channel or downlink control information.

11. The method according to claim 1, wherein
the first downlink transmission is one of a Downlink Semi Persistent Scheduling (SPS) transmission, and the method comprises:
in the case where a duration of a time slot configured for a transmission of acknowledgement (ACK)/negative ACK (NACK) of the first downlink transmission overlaps the cell DRX inactive period, delaying or stopping starting the transmission of the ACK/NACK of the first downlink transmission.

12. The method according to claim 11, wherein
the delaying or stopping the starting the transmission of the ACK/NACK is performed by updating a number of slots which the UE has to wait before the transmission of the ACK/NACK.

13. The method according to claim 1, wherein
the first downlink transmission includes information indicating a Semi Persistent Scheduling (SPS) release, and the method comprises:
in the case where a duration of a time slot configured for a transmission of acknowledgement (ACK)/negative ACK (NACK) of the SPS release overlaps the cell DRX inactive period, delaying or stopping starting the transmission of the ACK/NACK of the SPS release.

14. The method according to claim 11, further comprising:
in the case where data regarding the first downlink transmission was not successfully decoded, not flushing the data in an HARQ buffer.

15. The method according to claim 1, further comprising:
receiving, from the access network node, information indicating how long to delay or stop the starting the procedure.

16. A method performed by an access network node, the method comprising:
transmitting, to a user equipment (UE), a first downlink transmission; and
in a case where a timing of a procedure related to the first donwlink transmission overlaps a cell discontinuous transmission (DTX)/discontinuous reception (DRX) inactive period of the access network node, delaying or stopping starting the procedure related to the first downlink transmission.

17. A user equipment (UE), comprising:
at least one memory storing instructions; and
at least one processor configured to process the instructions to:
receive, from an access network node, a first downlink transmission;
determine that a timing of a procedure related to the first donwlink transmission overlaps a cell discontinuous transmission (DTX)/discontinuous reception (DRX) inactive period of the access network node; and
delay or stop starting the procedure related to the first downlink transmission.

18. (canceled)
